(19) United States
(12) Patent Application Publication
(10) Pub. No.: US 2012/0307059 A1
(43) Pub. Date: Dec. 6, 2012

(54) DIAGNOSIS APPARATUS AND DIAGNOSIS METHOD

(75) Inventors: Yuzuru YAMAKAGE, Kawasaki (JP); Shingo Hamaguchi, Kawasaki (JP); Kazuyuki Ozaki, Kawasaki (JP)

(73) Assignee: Fujitsu Limited

(21) Appl. No.: 13/481,146

(22) Filed: May 25, 2012

Related U.S. Application Data
(63) Continuation of application No. PCT/JP2009/006485, filed on Nov. 30, 2009.

(51) Int. Cl. G06K 9/46; H04N 7/18

(52) U.S. Cl. 348/148; 382/103; 348/E07.085

(57) ABSTRACT

A diagnosis apparatus includes an object extraction unit to extract one or more objects around a vehicle, a line-of-vision determination unit to determine whether or not at least one region of the object is included in a line-of-vision space centered around a line of vision of a driver of the vehicle, and a degree-of-recognition diagnosis unit to diagnose the driver's degree of recognition of the object in accordance with the determination result.

### CROSS-REFERENCE TO RELATED APPLICATION

This application is a continuation application of International PCT Application No. PCT/JP2009/006485, filed on Nov. 30, 2009, the entire contents of which are incorporated herein by reference.

### FIELD

The present invention relates to a diagnosis apparatus and diagnosis method for diagnosing the degree of a driver's recognition of objects around a vehicle.

### BACKGROUND

Promoting safety in order to decrease the number of accidents is a big challenge in the automotive community, and accordingly, various measures have been taken. As an example, air bags have been installed in vehicles to decrease the effects on the driver of any accidents the driver is in. Air bags are installed as a measure that works after accidents, and, as a measure for preventing an accident from occurring, a system has been developed for sensing an object which should be recognized, such as an obstacle around a vehicle. A safety guidance service has also been proposed wherein a driving state obtained while a driver is driving a vehicle is stored in a storage device, and a diagnostician diagnoses the driving state to give guidance to the driver. In addition, Japanese Laid-open Patent Publication No. 11-129924 discloses a system in which the driving ability of a driver is measured from, for example, her/his brake operations and accelerator operations, and the vehicle is controlled in accordance with the driver's ability.

### SUMMARY

According to an aspect of the embodiment, a diagnosis apparatus includes an object extraction unit configured to extract one or more objects around a vehicle, a line-of-vision determination unit configured to determine whether or not at least one region of the object is included in a line-of-vision space centered around a line of vision of a driver of the vehicle, and a degree-of-recognition diagnosis unit configured to diagnose the driver's degree of recognition of the object in accordance with the determination result.

According to an aspect of the embodiment, a diagnosis method executed by a diagnosis apparatus, the method includes extracting one or more objects around a vehicle, determining whether or not at least one region of the object is included in a line-of-vision space centered around a line of vision of a driver of the vehicle, and diagnosing the driver's degree of recognition of the object in accordance with the determination result.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of a block diagram illustrating a relationship of connection between a diagnosis apparatus and an information obtainment apparatus in accordance with a first embodiment and also illustrating the hardware configurations of these apparatuses;

FIG. 2 is an explanatory diagram illustrating attachment positions at which proximate area information obtainment devices are attached and also illustrating the image shooting ranges of these devices;

FIG. 3 is an explanatory diagram (1) illustrating an attachment position at which a line-of-vision detection device is attached;

FIG. 4 is an explanatory diagram (2) illustrating an attachment position at which a line-of-vision detection device is attached;

FIG. 5 is an explanatory diagram illustrating an example of a region that can be watched in a mirror;

FIG. 6 is a schematic view illustrating a three-dimensional plane of projection onto which a proximate area image is projected;

FIG. 7 is a perspective view illustrating a relationship between the vehicle in FIG. 6 and another vehicle;

FIG. 8 is an example of a block diagram illustrating the functional configurations of the information obtainment apparatus and the diagnosis apparatus in accordance with the first embodiment;

FIG. 9 is an explanatory diagram illustrating an example of a method for calculating a line-of-vision origin P and a line-of-vision vector;

FIG. 10 illustrates an example of proximate area information in a proximate area information DB;

FIG. 11 illustrates an example of line-of-vision data in a line-of-vision data DB;

FIG. 12 is an explanatory diagram illustrating an example of a method for extracting an object;

FIG. 13 illustrates an example of relative information in a relative information DB;

FIG. 14 is an explanatory diagram illustrating an example of a method for calculating a relative distance L;

FIG. 15 illustrates an example of a correspondence table indicating a relationship between TTCs and the degrees of risk.

FIG. 16 illustrates an example of a diagnosis result DB;

FIG. 17 is an explanatory diagram illustrating an example of a method for determining viewing in accordance with an angle Δθ formed by a line-of-vision vector and an object vector;

FIG. 18 is an explanatory diagram illustrating an example of a method for determining viewing in accordance with an angle Δθ formed by a mirror line-of-vision vector and an object vector;

FIG. 19 illustrates an example of viewing times and non-viewing times stored by the diagnosis result DB;

FIG. 20 illustrates an example of a correspondence table indicating a relationship between formed angles ΔθH and ΔθV and the degrees of recognition;

FIG. 21 is an explanatory diagram illustrating a method for diagnosing the degree of recognition in accordance with a viewing frequency or a viewing interval;

FIG. 22 is a flowchart illustrating an example of the flow of the entire process performed by the diagnosis apparatus in accordance with the first embodiment;

FIG. 23 is a flowchart illustrating an example of the flow of a mirror process for line-of-vision data in accordance with the first embodiment;

FIG. 24 is a flowchart illustrating an example of the flow of an object extraction process in accordance with the first embodiment;

FIG. 25 is a flowchart illustrating an example of the flow of a relative information calculation process in accordance with the first embodiment;

FIG. 26 is a flowchart illustrating an example of the flow of a degree-of-risk calculation process in accordance with the first embodiment;

FIG. 27 is a flowchart illustrating an example of the flow of a line-of-vision determination process in accordance with the first embodiment;

FIG. 28 is an explanatory diagram illustrating another method for calculating a TTC;

FIG. 29 illustrates an example of a block diagram indicating a hardware configuration of a diagnosis apparatus in accordance with a second embodiment; and

FIG. 30 is an example of a block diagram illustrating the functional configuration of the diagnosis apparatus in accordance with the second embodiment.

### DESCRIPTION OF EMBODIMENTS

According to one analysis, automobile accidents due to a driver not recognizing an object make up over 70% of all automobile accidents. Accordingly, to decrease vehicle accidents, it may be effective to evaluate the degree of recognition indicating the extent of a driver's recognition of an object so that safety measures based on the degree of recognition can be taken.

However, although systems for sensing an object such as the one described above, safety guidance services, the system for determining a driving ability disclosed by Japanese Laid-open Patent Publication No. 11-129924, and the like have developed technologies for reporting the existence of an object to a driver, the degree of the driver's actual recognition of an object has not been diagnosed.

Accordingly, embodiments of the present invention will provide a diagnosis apparatus and diagnosis method for diagnosing the degree of a driver's recognition of objects around the vehicle.

Preferred embodiments of the present invention will be explained with reference to accompanying drawings.

### [a] First Embodiment

A diagnosis apparatus 100 in accordance with a first embodiment obtains proximate area information of an area proximate to the vehicle and the driver's line of vision from an external information obtainment apparatus and diagnoses the degree of the driver's recognition of an object around the vehicle in accordance with the positional relationship between the driver's line of vision and the object. In the following, descriptions will be given of the relationship between the diagnosis apparatus in accordance with the first embodiment and the information obtainment apparatus and of their hardware configurations.

(1) Relationship Between Diagnosis Apparatus and Information Obtainment Apparatus

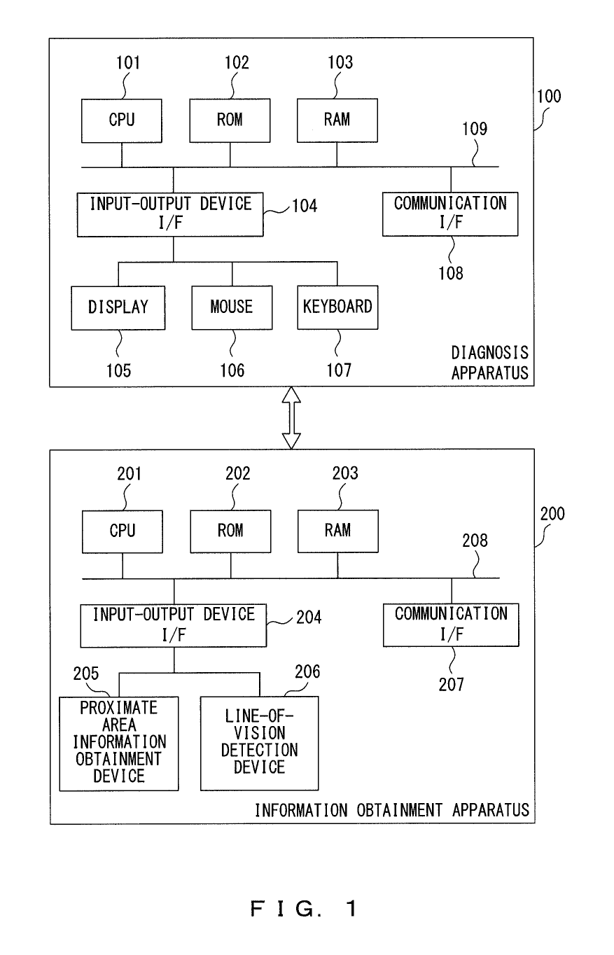

FIG. 1 is an example of a block diagram illustrating a relationship of connection between the diagnosis apparatus and the information obtainment apparatus in accordance with the first embodiment and also illustrating the hardware configurations of these apparatuses.

The diagnosis apparatus 100 is connected to obtain various information from an information obtainment apparatus 200. As an example, the diagnosis apparatus 100 is connected to the information obtainment apparatus 200 via an interface such as an SCSI (Small Computer System Interface) or a USB (Universal Serial Bus). The diagnosis apparatus 100 may be connected to the information obtainment apparatus 200 via a network such as the internet.

(2) Hardware Configuration

(2-1) Diagnosis Apparatus

The diagnosis apparatus 100 includes, for example, a CPU (Central Processing Unit) 101, a ROM (Read Only Memory) 102, a RAM (Random Access Memory) 103, an input-output device I/F 104, and a communication I/F (InterFace) 108. These elements are connected to each other via a bus 109.

The input-output device I/F 104 is connected to input-output devices such as a display 105, a speaker 106, and a keyboard 107, and it outputs a diagnosis result to the input-output devices in accordance with an instruction from, for example, the CPU 101.

The ROM 102 stores various control programs relating to various controls performed by the diagnosis apparatus 100, and these controls will be described hereinafter.

The RAM 103 temporarily stores, for example, the various control programs within the ROM 102 and various information obtained from the information obtainment apparatus 200. The various information includes, for example, proximate area information of an area proximate to the vehicle and the driver's line of vision. The RAM 103 temporarily stores information such as various flags in accordance with the execution of the various control programs.

The CPU 101 expands the various control programs stored by the ROM 102 within the RAM 103 and performs various controls, and these controls will be described hereinafter.

In accordance with control of the CPU 101, the communication I/F 108 communicates with, for example, the information obtainment apparatus 200, e.g., transmits or receives a command or data to or from the information obtainment apparatus 200.

The bus 109 is composed of, for example, a PCI (Peripheral Component Interconnect) bus or an ISA (Industrial Standard Architecture) bus and connects the aforementioned components to each other.

(2-2) Information Obtainment Apparatus

The information obtainment apparatus 200 includes, for example, a CPU 201, a ROM 202, a RAM 203, an input-output device I/F 204, and a communication I/F 207. They are connected to each other via a bus 208.

(a) Input-Output Device I/F

The input-output device I/F 204 is connected to, for example, a proximate area information obtainment device 205 and a line-of-vision detection device 206. Information detected by the proximate area information obtainment device 205 and the line-of-vision detection device 206 is output via the input-output device I/F 204 to, for example, the RAM 203, the CPU 201, and the communication I/F.

(b) Proximate Area Information Obtainment Device

The proximate area information obtainment device 205 obtains proximate area information including information on one or more objects around the vehicle. Proximate area information is, for example, a proximate area image of an area proximate to the vehicle and object information indicating the position, size, and the like of an object around the vehicle. In the present embodiment, the proximate area information obtainment device 205 obtains a proximate area image as proximate area information. As an example, the proximate area information obtainment device 205 is composed of an image pickup apparatus such as a CCD (Charge Coupled Device) camera or a CMOS (Complementary Metal Oxide Semiconductor) camera, and it obtains the proximate area image of an area proximate to the vehicle.

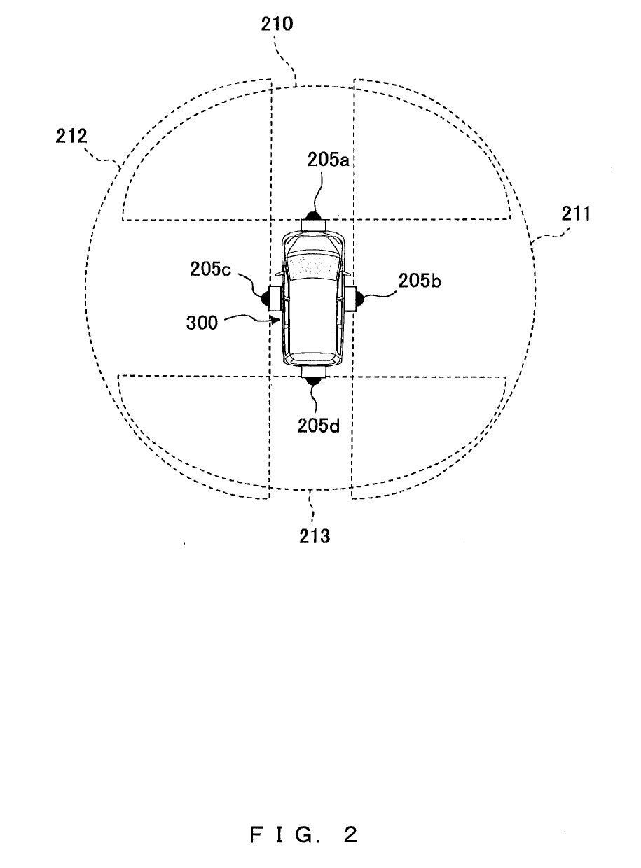

FIG. 2 is an explanatory diagram illustrating attachment positions at which proximate area information obtainment devices are attached and also illustrating the image shooting ranges of these devices. As illustrated in, for example, FIG. 2, the proximate area information obtainment device 205 is configured with, for example, four cameras, a front camera 205a, a right camera 205b, a left camera 205c, and a rear camera 205d. The front camera 205a is attached at the center of the front bumper of a vehicle 300 to shoot an image of the view ahead of the vehicle 300. The rear camera 205d is attached at the center of the rear bumper of the vehicle 300 to shoot an image of the view behind the vehicle 300. The right camera 205b is attached at the center of the right-side face of the vehicle 300 to shoot an image of the view to the right of the vehicle 300. The left camera 205c is attached at the center of the left-side face of the vehicle 300 to shoot an image of the view of a region to the left of the vehicle 300.

The cameras 205a to 205d are each, for example, a camera using a superwide-angle lens with an angle of view of 180°. Accordingly, as illustrated in FIG. 2, the front camera 205a shoots an image of a forward region 210, which is a region in front of the vehicle 300, the right camera 205b shoots an image of the view of a right-side region 211, which is a region to the right of the vehicle 300, the left camera 205c shoots an image of the view of a left-side region 212, which is a region to the left of the vehicle 300, and the rear camera 205d shoots an image of the view of a rear region 213, which is a region behind the vehicle 300. The region shot by each of the cameras 205a to 205d overlaps with the regions shot by the adjacent cameras.

Images shot by the cameras 205a to 205d are corrected in accordance with the attachment positions, the attachment angles, or the like of each of the cameras 205a to 205d so that these images can be applied to a spatial coordinate system which includes a central point O of the vehicle 300 as its origin, and this spatial coordinate system will be described hereinafter.

It is preferable that, as illustrated, the cameras 205a to 205d be attached at the centers of the front face, right-side face, left-side face, and rear face of the vehicle 300, respectively. However, as long as the cameras 205a to 205d are positioned so that the region shot by each of the cameras 205a to 205d can partially overlap with regions shot by the adjacent cameras, the attachment positions of the cameras 205a to 205d are not particularly limited. As an example, the right camera 205b and the left camera 205c may be attached to the right-side door mirror and the left-side door mirror of the vehicle 300. In addition, as long as the regions shot by the cameras are partially overlapped and the cameras can take images covering a 360-degree view around the vehicle, the number of the cameras is not limited to four.

The cameras 205a to 205d each shoot, for example, thirty frames per second. Image data shot by the proximate area information obtainment device 205 composed of the cameras 205a to 205d is stored in the RAM 203 via the input-output device I/F 204.

Since images are shot by the cameras 205a to 205d as described above, the diagnosis apparatus 100 may obtain the proximate area image of the entire region around the vehicle 300 by using an image processing unit 122 which will be described hereinafter. Accordingly, the diagnosis apparatus 100 may extract objects in the entire region around the vehicle 300, and hence it may even extract an object located at a blind spot of the driver of the vehicle 300.

(a) Line-of-Vision Detection Device

Next, the line-of-vision detection device 206 detects line-of-vision information on, for example, the driver's face, eyeball, and iris.

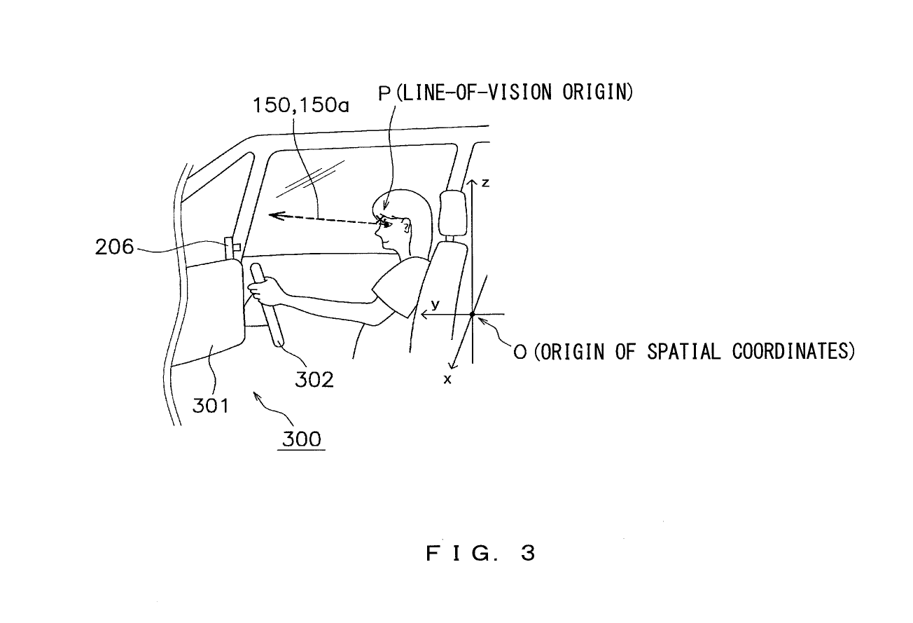

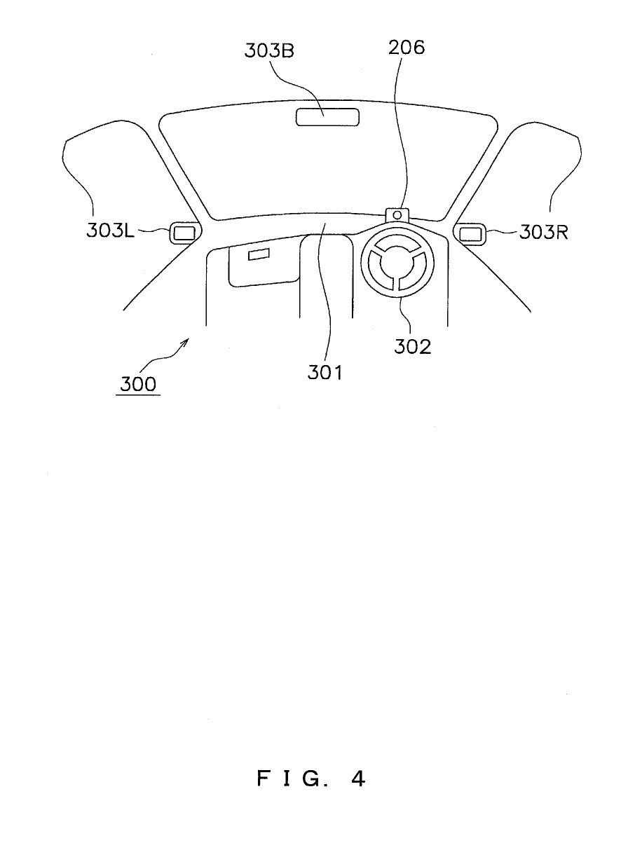

FIGS. 3 and 4 are each an explanatory diagram illustrating an attachment position at which a line-of-vision detection device is attached. The line-of-vision detection device 206 is composed of an image pickup apparatus, e.g., a CCD camera, a CMOS camera, or an infrared camera, which is capable of obtaining the driver's line-of-vision information.

The line-of-vision detection device 206 is equipped on, for example, a dashboard 301 of the vehicle 300, as indicated in FIGS. 3 and 4. In this case, the line-of-vision detection device 206 is attached at a predetermined angle on, for example, a portion of the dashboard 301 which is in the vicinity of a handle 302, so that the images of the driver's face, eye, and the like can be detected from the front or so that the images of the face, the eye, and the like can be shot without being blocked by the handle 302. However, as long as the driver's face, eye, and the like can be detected, the attachment position, the attachment angle, or the like is not limited.

Images shot by the line-of-vision detection device 206 are corrected in accordance with the attachment position and the attachment angle of the line-of-vision detection device 206 so that a line-of-vision origin P and the like detected from these images can be defined as coordinates of the spatial coordinate system centered around the central point O of the vehicle 300.

The line-of-vision detection device 206 shoots, for example, thirty image frames per second, and the shot image data is stored in the RAM 203 via the input-output device I/F 204.

A line of vision 150 may be detected in accordance with the image of the driver's face, eyes, iris, or the like detected by the line-of-vision detection device 206. Upon detection of the driver's line of vision 150, which direction the driver viewed is recognized in accordance with the direction of the line of vision 150. As an example, when the direction of the line of vision 150 is a fore direction, it may be presumed that the driver viewed a region ahead. When the direction of the line of vision 150 is directed to a mirror 303, it may be presumed that the driver viewed, in the mirror 303, an area behind the vehicle 300, a rear half of the region lateral to the vehicle 300, or the like.

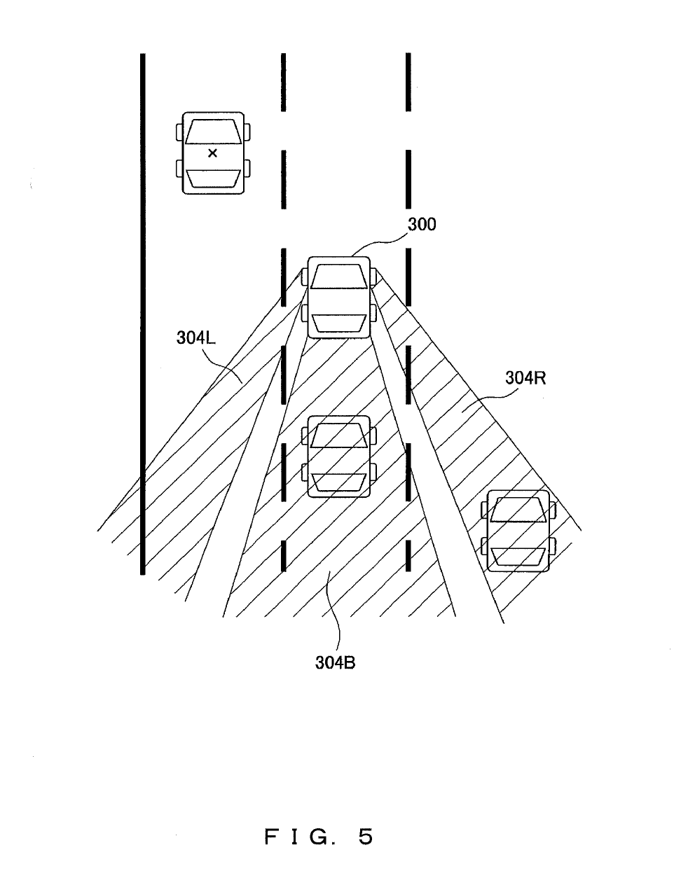

As indicated in FIG. 4, the mirrors 303 equipped on the vehicle 300 may be, for example, door mirrors 303L and 303R equipped near the right-side and left-side doors of the vehicle 300, a back mirror 303B equipped inside the vehicle 300, and a fender mirror equipped on the bonnet of the vehicle 300. FIG. 5 is an explanatory diagram illustrating an example of a region that can be watched in a mirror. The driver of the vehicle 300 may watch a left-side mirror region 304L, a right-side mirror region 304R, and a back mirror region 304B in the left-side door mirror 303L, the right-side door mirror 303R, and the back mirror 303B, respectively.

(d) ROM, RAM, and Communication I/F

The ROM 202 stores various control programs executed by the information obtainment apparatus 200.

The RAM 203 temporarily stores various control programs within the ROM 202, various flags, and various information received from the proximate area information obtainment device 205 and the line-of-vision detection device 206.

Under control of the CPU 201, the communication I/F 207 transmits or receives, to or from the diagnosis apparatus 100, data such as a proximate area image obtained by the proximate area information obtainment device 205, line-of-vision information detected by the line-of-vision detection device 206, and various commands.

(e) CPU

The CPU 201 expands various control programs stored in the ROM 202 within the RAM 203 to perform the various controls. As an example, upon execution of the various control programs, the CPU 201 controls and causes the proximate area information obtainment device 205 and the line-of-vision detection device 206 to start obtaining proximate area images and line-of-vision information. In accordance with the line-of-vision information, the CPU 201 also detects, for example, the line-of-vision origin P and a line-of-vision vector 150a indicating the direction of the line of vision 150. Note that the line-of-vision origin P and the line-of-vision vector 150a are defined by, for example, a spatial coordinate system including an optional central point O of the vehicle 300 as the origin, as illustrated in FIG. 3. As an example, the central point O is defined as a position corresponding to the midpoint of the width of the vehicle 300 and the midpoint of the length. The spatial coordinate system is represented as X, Y, and Z coordinates, and the central point O is represented as (X, Y, Z)=(0, 0, 0).

(3) Outline of Processes

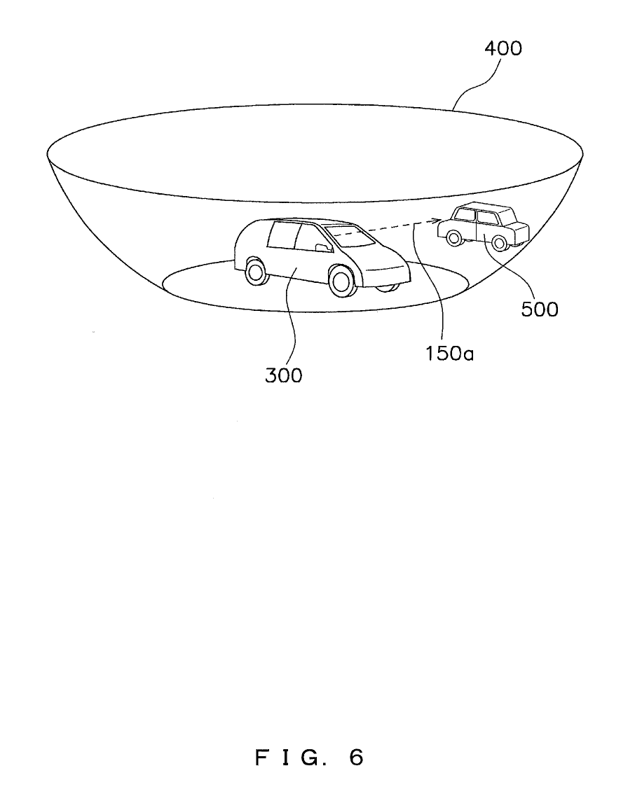

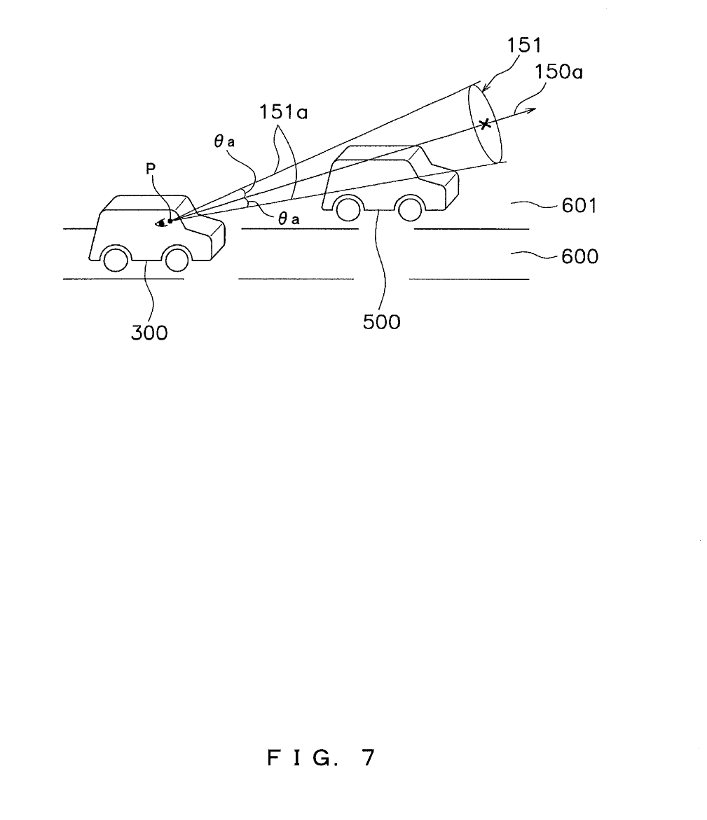

The outline of the processes performed by the diagnosis apparatus 100 will be described with reference to FIGS. 6 and 7. In the following descriptions, the vehicle 300 is a vehicle driven by a driver for whom the degree of recognition of objects is diagnosed, and another vehicle 500 is a vehicle that could be an object relative to the vehicle 300.

FIG. 6 is a schematic view illustrating a three-dimensional plane of projection onto which a proximate area image is projected.

The diagnosis apparatus 100 first receives the proximate area image of the region around the vehicle 300 from the information obtainment apparatus 200 to grasp an object around the vehicle 300. The object is an obstacle around the vehicle 300, and, in detail, it is an obstacle around the vehicle 300 which the driver should recognize while driving the vehicle 300. Objects include, for example, a body that can be an obstacle to the traveling of vehicles such as cars, bicycles, and motorcycles, or the traveling of humans, animals, and the like.

Next, the diagnosis apparatus 100 projects the proximate area image onto a three-dimensional plane of projection 400 as illustrated in FIG. 6. As an example, the three-dimensional plane of projection 400 has a bowl-shaped plane of projection centered around the vehicle 300. As a result, the diagnosis apparatus 100 may grasp objects around the vehicle 300. In FIG. 6, another vehicle 500, which is an object, is positioned ahead of and to the left of the vehicle 300.

FIG. 7 is a perspective view illustrating a relationship between the vehicle in FIG. 6 and another vehicle. The other vehicle 500 is running on a lane 601 which is to the left of and adjacent to a lane 600 on which the vehicle 300 is running. Since the line-of-vision vector 150a of the driver of the vehicle 300 is directed to the other vehicle 500, the diagnosis apparatus 100 may determine that the driver of the vehicle 300 is viewing the other vehicle 500. In particular, as an example, the diagnosis apparatus 100 establishes a line-of-vision space 151 centered around the line of vision 150 of the driver of the vehicle 300 and determines whether or not the driver of the vehicle 300 is viewing the other vehicle 500 in accordance with whether or not the line-of-vision space 151 includes at least one region of the other vehicle 500 which is an object. The diagnosis apparatus 100 makes the determination in accordance with an angle Δθ formed by the line-of-vision vector 150a and an object vector 160a directed from the vehicle 300 toward the other vehicle 500, and this will be more specifically described hereinafter. Here, the line-of-vision space 151 is a space formed by the collection of line-of-vision space lines 151a extending from the line-of-vision origin P and forming the angle Δθ with the line-of-vision vector 150a which is equal to a predetermined threshold θth or smaller.

(4) Functional Configuration

Next, the functional configurations of the information obtainment apparatus 200 and the diagnosis apparatus 100 will be described.

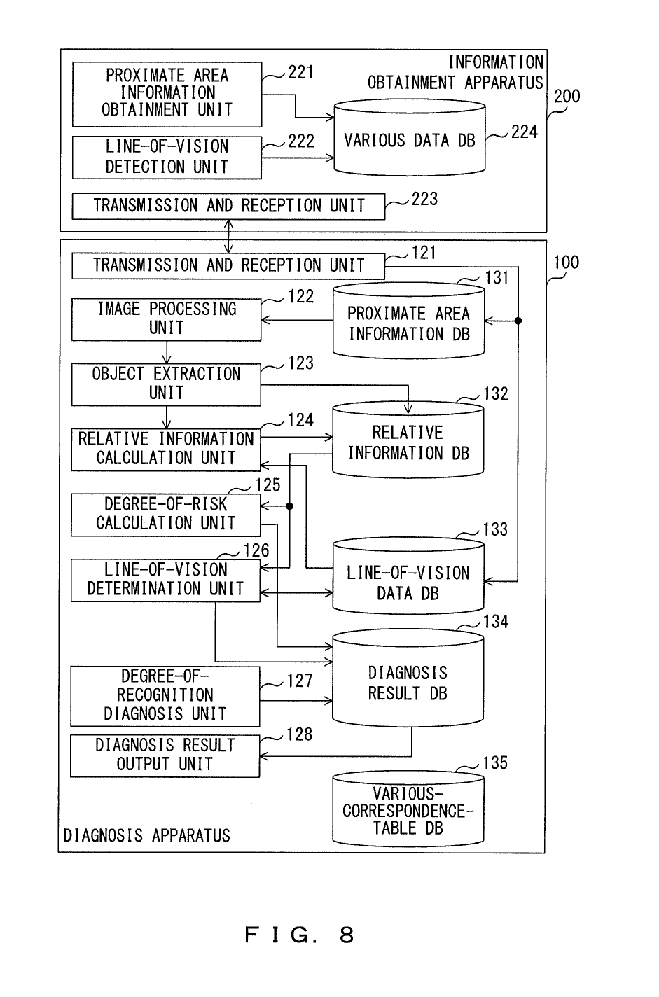

FIG. 8 is an example of a block diagram illustrating the functional configurations of the information obtainment apparatus and the diagnosis apparatus in accordance with the first embodiment. The connect lines of the function parts in FIG. 8 indicate examples of data flows and do not indicate all of the data flows.

Firstly, the functional configuration of the information obtainment apparatus 200 will be described.

(4-1) Information Obtainment Apparatus

Processes of the functional parts of the information obtainment apparatus 200 are executed via the CPU 201, the ROM 202, the RAM 203, the input-output device I/F 204, the proximate area information obtainment device 205, the line-of-vision detection device 206, the communication I/F 207, and the like working in cooperation with each other.

The functional parts of the information obtainment apparatus 200 include, for example, a proximate area information obtainment device 221, a line-of-vision detection unit 222, a transmission and reception unit 223, and various-data DB 224.

(4-1-1) Proximate Area Information Obtainment Unit

The proximate area information obtainment device 221 obtains a proximate area image shot by the proximate area information obtainment devices 205 including the front camera 205a, the right camera 205b, the left camera 205c, and the rear camera 205d illustrated in FIG. 2 described above, and stores this image in the various-data DB 224.

(4-1-2) Line-of-Vision Detection Unit

In accordance with the image of a driver's face, eye, iris, or the like detected by the line-of-vision detection device 206, the line-of-vision detection unit 222 calculates the line-of-vision vector 150a indicating the line-of-vision origin P and the direction of the line of vision 150.

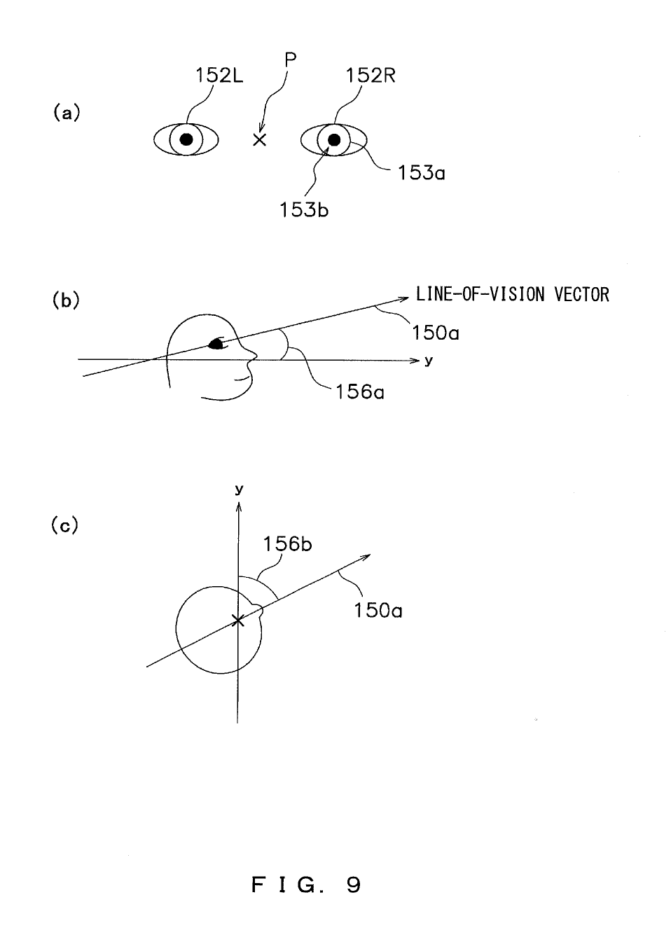

FIG. 9 is an explanatory diagram illustrating an example of a method for calculating the line-of-vision origin P and the line-of-vision vector. As an example, the line-of-vision detection unit 222 calculates a characteristic point of the face in accordance with the image of the face, eye, iris, or the like and compares it with a characteristic amount of the driver's face stored in advance. Next, the line-of-vision detection unit 222 extracts the face direction in accordance with the comparison result, the image of the face, eye, or iris, or the like, and detects, as the line-of-vision origin P, the intermediate position between a left eyeball 152L and a right eyeball 152R indicated in FIG. 9 (a). In addition, the line-of-vision detection unit 222 calculates the central position of an iris 153a, i.e., the central position of a pupil 153b. Finally, the line-of-vision detection unit 222 calculates the line-of-vision vector 150a in accordance with the line-of-vision origin P and the central position of the pupil 153b. Since the driver is able to move her/his head in, for example, the fore, aft or side directions, the position of the line-of-vision origin P relative to the central point O of the spatial coordinate system is changed in accordance with the position, direction, or the like of the head.

The line-of-vision vector 150a may be defined by coordinates within the spatial coordinate system which includes the optional central point O of the vehicle 300 as the origin. Alternatively, the line-of-vision vector 150a may be defined by a pitch angle 156a formed by the line-of-vision vector 150a and an XY plane and an azimuth angle 156b formed by the line-of-vision vector 150a and a YZ plane, as illustrated in FIGS. 9 (b) and 9 (c).

The line-of-vision detection unit 222 stores the line-of-vision origin P and the line-of-vision vector 150a in the various-data DB 224.

(4-1-3) Transmission and Reception Unit

A transmission and reception unit 223 of the information obtainment apparatus 200 transmits or receives, for example, various commands and various data within various-data DB 224 to or from a transmission and reception unit 121 of the diagnosis apparatus 100.

(4-2) Diagnosis Apparatus

Processes of the functional parts of the diagnosis apparatus 100 are executed via the CPU 101, the ROM 102, the RAM 103, the input-output device I/F 104, the display 105, the speaker 106, the keyboard 107, the communication I/F 108, and the like working in cooperation with each other.

The functional parts of the diagnosis apparatus 100 include, for example, the transmission and reception unit 121, the image processing unit 122, an object extraction unit 123, a relative information calculation unit 124, a degree-of-risk calculation unit 125, a line-of-vision determination unit 126, a degree-of-recognition diagnosis unit 127, and a diagnosis result output unit 128. In addition, to store various information, the functional parts of the diagnosis apparatus 100 include, for example, a proximate area information DB 131, a relative information DB 132, a line-of-vision data DB 133, a diagnosis result DB 134, and a various-correspondence-table DB 135.

(4-2-1) Transmission and Reception Unit

A transmission and reception unit 121 of the diagnosis apparatus 100 transmits or receives, for example, various data and various commands to or from a transmission and reception unit 223 of the information obtainment apparatus 200.

(4-2-2) Proximate Area Information DB

The proximate area information DB 131 obtains the proximate area image of a region around the vehicle from the information obtainment apparatus 200 and stores this image as proximate area information including information on an object around the vehicle. The proximate area image includes an image shot by the proximate area information obtainment devices 205 including the front camera 205a, the right camera 205b, the left camera 205c, and the rear camera 205d.

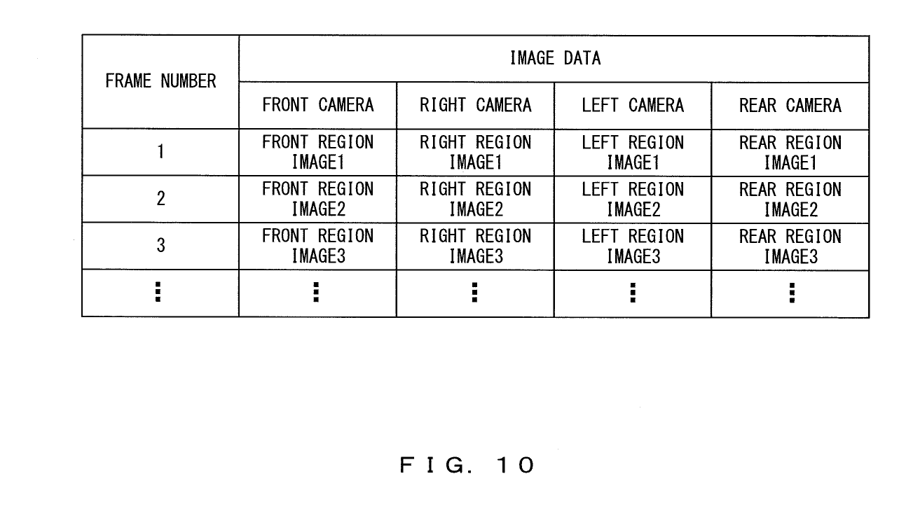

FIG. 10 illustrates an example of proximate area information of a proximate area information DB. For each frame, the proximate area information DB 131 stores, for example, a frame number and image data obtained by each of the cameras 205. The image data includes a front region image shot by the front camera 205a, a right region image shot by the right camera 205b, a left region image shot by the left camera 205c, and a rear region image shot by the rear camera 205d.

(4-2-3) Line-of-Vision Data DB

The line-of-vision data DB 133 obtains the line-of-vision origin P and the line-of-vision vector 150a of the driver of the vehicle from the information obtainment apparatus 200 and stores them. The line-of-vision data DB 133 also stores, for example, the presence/absence of the viewing of the mirrors 303, a mirror line-of-vision origin R, and a mirror line-of-vision vector 155a, which are determined by the line-of-vision determination unit 126.

The mirror line-of-vision origin R represents the coordinates of the intersection between the line-of-vision vector 150a and the region of the mirror plane of the mirror 303. The line of vision 150 from the driver is reflected from the mirror 303 and turns into a mirror line-of-vision 155. The mirror line-of-vision vector 155a is a vector indicating the direction of the mirror line-of-vision 155. The mirror line-of-vision origin R and the mirror line-of-vision vector 155a are defined by the spatial coordinate system centered around an optional central point O of the vehicle 300.

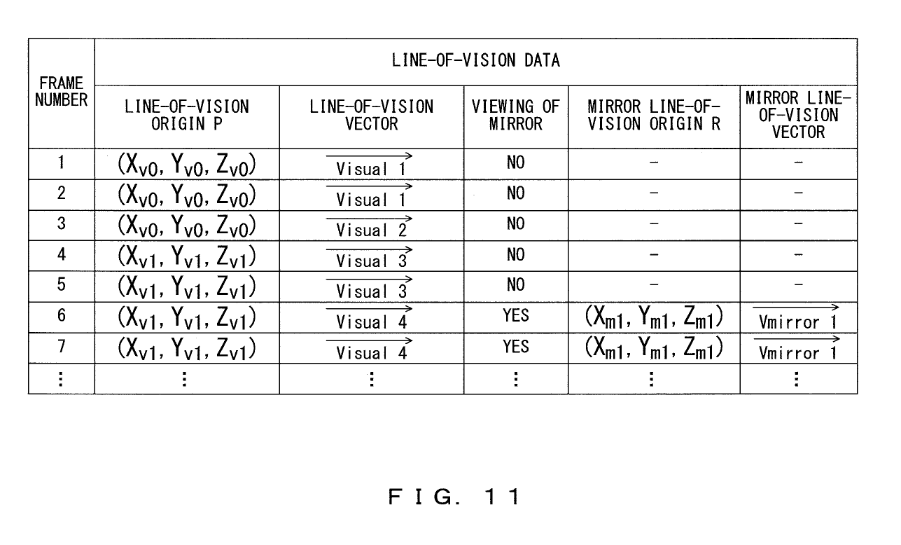

FIG. 11 illustrates an example of line-of-vision data in the line-of-vision data DB. For each frame, the line-of-vision data DB 133 stores a frame number, the line-of-vision origin P, the line-of-vision vector 150a, Yes/No of the viewing of the mirror, the mirror line-of-vision origin R, and the mirror line-of-vision vector 155a. As an example, in the record of the frame number 1, the line-of-vision data DB 133 stores a line-of-vision origin P (Xv0, Yv0, Zv0), a line-of-vision vector Visual 1, and “NO” indicating that the mirror 305 was not viewed. At the record of the frame number 6, the line-of-vision data DB 133 stores a line-of-vision origin P (Xv1, Yv1, Zv1), a line-of-vision vector Visual 4, “Yes” indicating that the mirror 303 was viewed, a mirror line-of-vision origin R (Xm1, Ym1, Zm1), and a mirror line-of-vision vector Vmirror 1.

(4-2-4) Image Processing Unit

The image processing unit 122 obtains pieces of image data of images shot by the cameras 205 from the proximate area information DB 131 and synthesizes them to generate a proximate area image projected onto the aforementioned three-dimensional plane of projection 400 as illustrated in FIG. 6. In particular, first, the image processing unit 122 obtains the correspondence between each pixel of each of the cameras 205a to 205d and each coordinate of the three-dimensional plane of projection 400 from the various-correspondence-table DB 135. The various-correspondence-table DB 135 will be described hereinafter. Next, in accordance with the correspondence with the coordinates, the image processing unit 122 projects the image data of the cameras 205a to 205d onto the three-dimensional plane of projection 400 to generate a proximate area image.

(4-2-5) Object Extraction Unit

The object extraction unit 123 extracts one or more objects around the vehicle 300 from the proximate area image generated by the image processing unit 122.

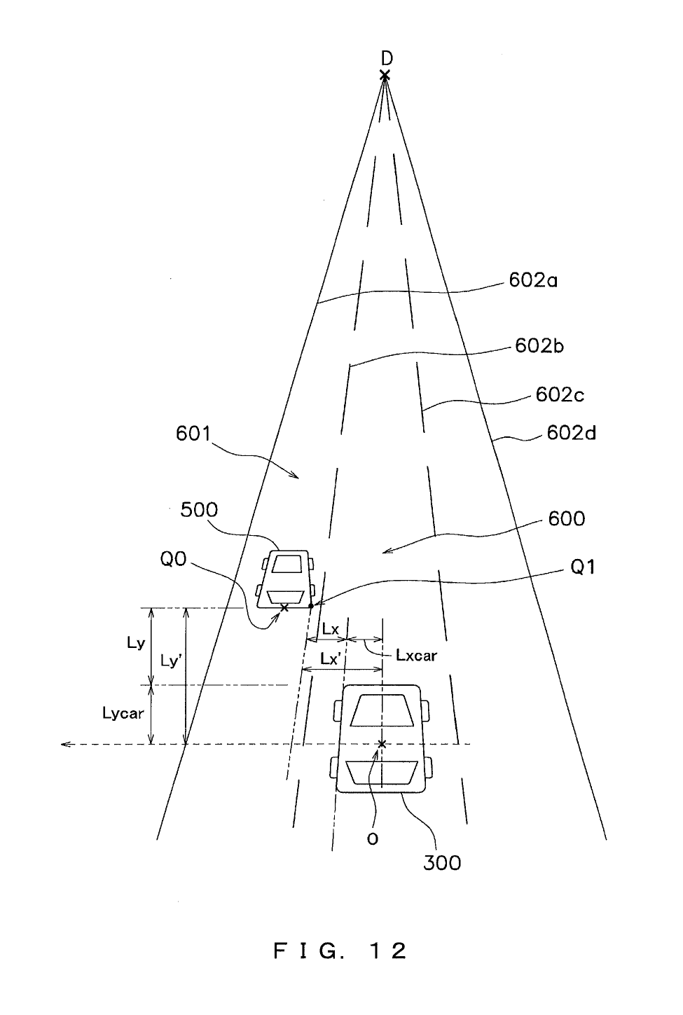

FIG. 12 is an explanatory diagram illustrating an example of a method for extracting an object. In FIG. 12, the vehicle 300 is running on the lane 600, and the other vehicle 500, which is an object, is running on the lane 601 which is to the left of and adjacent to the lane 600. First, the object extraction unit 123 extracts edges in accordance with, for example, the luminance contrast ratio of the proximate area image so as to detect lane-indicating lines 602a to 602d. Next, the object extraction unit 123 detects a vanish point D from the intersection between the lane-indicating lines 602a to 602d, and, in accordance with the vanish point D, it establishes the search range of objects in which they are searched for. As an example, the search range may be established as a range surrounded by the vanish point D and the lane-indicating lines 602a to 602d or as a predetermined range including this range.

The object extraction unit 123 extracts an object candidate around the vehicle 300 within the search range. The object candidate is a candidate that can be an object. Next, the object extraction unit 123 determines whether or not the object candidate should be defined as an object by comparing the object candidate with pattern data that is stored in advance and that stores various characteristics of objects. As an example, when the object candidate is identical with the pattern data of a vehicle, the object extraction unit 123 determines that the object candidate is an object. However, objects are not limited to vehicles, and they may be, for example, a human. In the example of FIG. 12, the object extraction unit 123 extracts the other vehicle 500 as an object. Meanwhile, when the object candidate is not identical with the pattern data of an object, the object extraction unit 123 determines that the object candidate is not an object.

The object extraction unit 123 assigns an object ID (IDentification) to each extracted object to identify them, and it obtains the relative positions of the objects with respect to the vehicle 300. The relative positions may be, for example, the central coordinates of one edge of the object that is the closest to the vehicle 300 or the coordinates of a portion of the object that is the closest to the vehicle 300. When the other vehicle 500 is running at a position ahead of and to the left of the vehicle 300 as illustrated in FIG. 12, the object extraction unit 123 obtains, as relative positions, the central point Q0 of the rear portion of the other vehicle 500 and the right corner point Q1 of the other vehicle 500. Meanwhile, when the other vehicle 500 is running at a position behind and to the right of the vehicle 300, the object extraction unit 123 obtains, as relative positions, the central point Q0 of the front portion of the other vehicle 500 and the left corner point Q1 of the other vehicle 500.

Here, the relative positions Q0 and Q1 are defined by the spatial coordinate system including an optional central point O of the vehicle 300 as the origin. As long as the object extraction unit 123 can grasp the position of an object, the relative positions of the object are not limited to the aforementioned relative positions Q0 and Q1.

The object extraction unit 123 stores the object ID and the relative positions Q0 and Q1 in the relative information DB 132.

(4-2-6) Relative Information Calculation Unit, Relative Information DB

For each frame and each object, the relative information DB 132 stores an object ID and relative positions Q0 and Q1 obtained from the object extraction unit 123. For each frame and each object, the relative information DB 132 also stores, for example, an object vector 160a and a relative distance L and a relative speed V calculated by the relative information calculation unit 124.

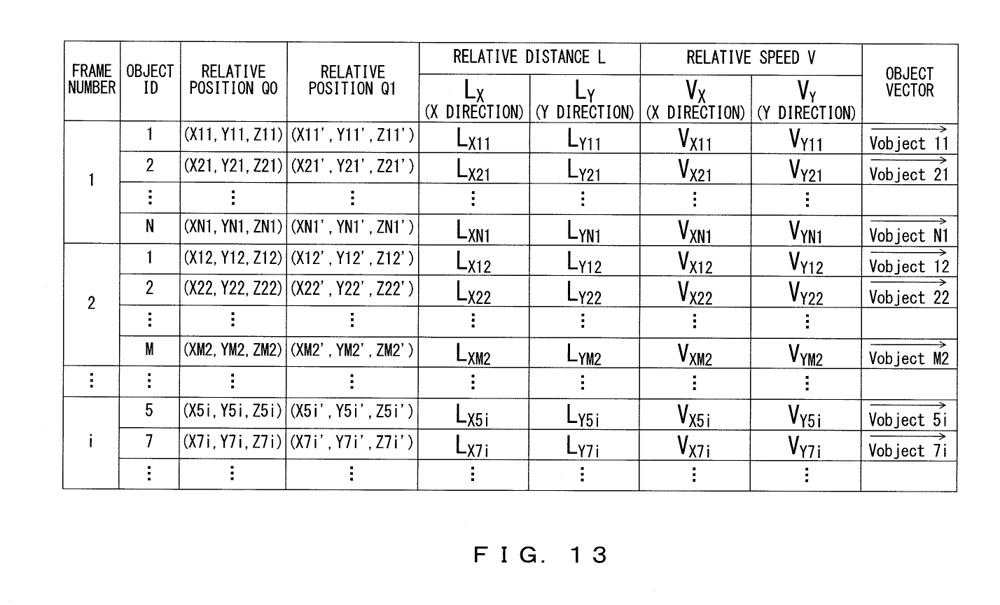

FIG. 13 illustrates an example of relative information in a relative information DB. The relative information DB 132 stores, for example, frame numbers, object IDs, relative positions Q0, relative positions Q1, relative distances L, relative speeds V, and object vectors 160a. The relative distances L include X-direction relative distances Lx and Y-direction relative distances Ly. The relative speeds V include X-direction relative speeds Vx and Y-direction relative speeds Vy. The object vector 160a indicates the direction 160 from the line-of-vision origin P or the mirror line-of-vision origin R toward an object.

The relative information calculation unit 124 calculates relative information such as the object vector 160a and the relative distances L and the relative speeds V between the vehicle 300 and one or more objects. A method for calculating relative information will be described using FIG. 12 again. First, the relative information calculation unit 124 reads the relative position Q1 of an object from the relative information DB 132. The relative information calculation unit 124 calculates an X-direction relative distance Lx′ and a Y-direction relative distance Ly′ in accordance with the distance between the central point O of the vehicle 300 and the relative position Q1 of the object. In case the other vehicle 500 is an object, the relative position Q1 is the coordinates of a portion of the other vehicle 500 which is the closest to the vehicle 300. Referring to the relative information DB 132 in FIG. 13, the relative position Q0 is (X21, Y21, Z21) for the frame number 1 and the object ID 2. Since the coordinates of the central point O are (0, 0, 0), the X-direction relative distance Lx′ is calculated as Lx′=X21−0=X21. Similarly, the Y-direction relative distance Ly′ is calculated as Ly′=Y21−0=Y21. Here, the relative distance Lx′ and the Y-direction relative distance Ly′ are distances including half of the width of the vehicle 300 and half of the length. Accordingly, the relative information calculation unit 124 calculates a relative distance Lx by subtracting, from the relative distance Lx′, Lxcar, which is half of the X-direction width of the vehicle 300. Similarly, the relative information calculation unit 124 calculates a relative distance Ly by subtracting, from the relative distance Ly′, Lycar, which is half of the y-direction length of the vehicle 300.

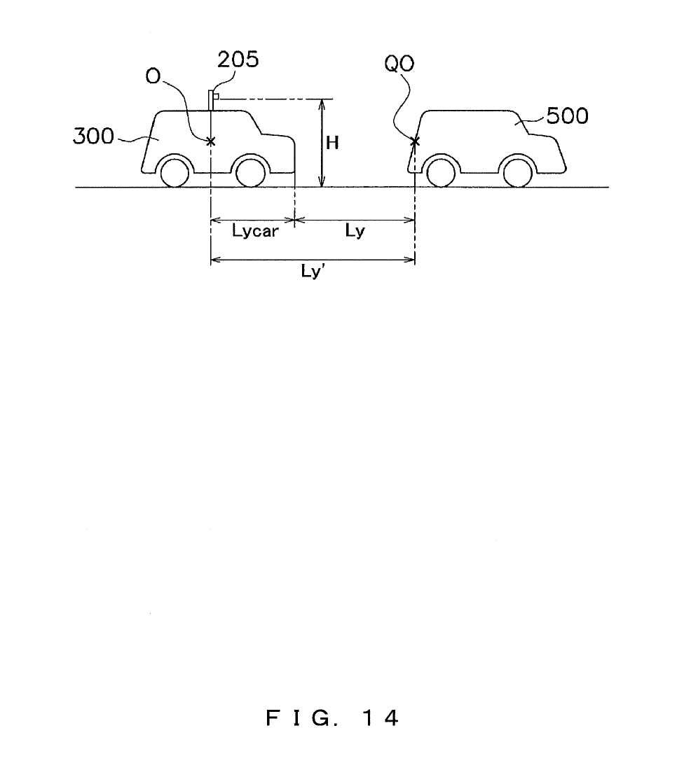

As a method for calculating a more specific relative distance L, an exemplary method for calculating a relative distance will be described in the following, wherein the focal length, the height of the position at which the camera 205 is equipped, and the like are considered. FIG. 14 is an explanatory diagram illustrating an example of a method for calculating a relative distance L. The camera 205 for shooting the proximate area image of a proximate area of the vehicle 300 is provided on a portion of the vehicle body above the central point O of the vehicle 300. The height of the camera 205 above the ground is H, the focal length of the lens of the camera 205 is f, and the coordinates of the vanish point D are (XD, YD, ZD). Here, when the relative position Q0 of the object, the other vehicle 500, is (XQ0, YQ0, ZQ0), the relative information calculation unit 124 calculates the relative distance Lx′ and the relative distance Ly′ in accordance with the following formulae (1) and (2).

Relative distance Ly′=f×H/|YQ0−YD| (1)

Relative distance Lx′=Ly′×f/|XQ0−XD| (2)

The relative information calculation unit 124 calculates the relative distances Lx and Ly as described above in accordance with the relative distances Lx′ and Ly′, Lxcar, and Lycar, and stores the calculated distances in the relative information DB 132. As a result, the relative distances Lx and Ly within the current frame currently focused on may be calculated.

Next, the relative information calculation unit 124 obtains the relative distances Ly and Lx of the object focused on within the frame immediately preceding the current frame. That is, for the same object, the relative information calculation unit 124 calculates the difference between the relative distance L in the previous frame and that in the current frame. Next, the relative information calculation unit 124 calculates a Y-direction relative speed Vy in accordance with the difference between the relative distance Ly in the current frame and that in the previous frame and the time period between the frames. Similarly, the relative information calculation unit 124 calculates an X-direction relative speed Vx in accordance with the difference between the relative distance Lx in the current frame and that in the previous frame and the time period between the frames.

In addition, the relative information calculation unit 124 obtains the line-of-vision origin P or the mirror line-of-vision origin R from the line-of-vision data DB 133. In particular, the relative information calculation unit 124 obtains the line-of-vision origin P when the result of the viewing of the mirror indicates the judgment of “NO” in the line-of-vision data DB 133, and it obtains the mirror line-of-vision origin R when the result of the viewing of the mirror indicates the judgment of “YES”. The relative information calculation unit 124 also obtains, from the relative information DB 132, the relative position Q0 of the object for which an object vector to be calculated. Next, the relative information calculation unit 124 calculates the object vector 160a which indicates the direction 160 from the line-of-vision origin P or the mirror line-of-vision origin R toward the object.

In regard to the frame number 1 and the object ID 2, the object vector 160a is calculated as follows. The relative information calculation unit 124 obtains the line-of-vision origin P (Xv0, Yv0, Zv0) from the line-of-vision data DB 133 since the result of the viewing of the mirror indicates the judgment of “NO”. The relative information calculation unit 124 also obtains the relative position Q0 (X21, Y21, Z21) from the relative information DB 132. Next, the relative information calculation unit 124 calculates an object vector Vobject 21 in accordance with the line-of-vision origin P (Xv0, Yv0, Zv0) and the relative position Q0 (X21, Y21, Z21).

In regard to the frame number 6 and the object ID 2, the object vector 160a is calculated as follows. The relative information calculation unit 124 obtains the mirror line-of-vision origin R (Xm1, Ym1, Zm1) from the line-of-vision data DB 133 since the result of the viewing of the mirror indicates the judgment of “YES”. Here, assume that the relative position Q0 for the frame number 6 and the object ID 1 is (X26, Y26, Z26). The relative information calculation unit 124 calculates an object vector Vobject 26 in accordance with the mirror line-of-vision origin R (Xm1, Ym1, Zm1) and the relative position Q0 (X26, Y26, Z26).

The object vector 160a may be defined by coordinates within the spatial coordinate system or may be defined by the angle formed by the object vector 160a and the XY plane and that formed by the object vector 160a and the YZ plane.

The relative information calculation unit 124 stores the calculation results above in the relative information DB 132.

Since objects move closer to or away from the vehicle 300, the number of objects increases or decreases. As an example, the number of objects in the frame with the frame number 1 in FIG. 13 is “N”, and the number in the frame with the frame number 2 is “M”, which is different from “N”. The objects with the frame IDs “1” to “4” were present in the frame with the frame number 1 but are not present in that with the frame number i.

(4-2-7) Degree-of-Risk Calculation Unit and Diagnosis Result DB

The degree-of-risk calculation unit 125 calculates the degree of risk of a collision between an object and the vehicle 300 in accordance with, for example, relative information within the relative information DB 132. As an example, the degree-of-risk calculation unit 125 calculates a degree of risk as follows.

The degree-of-risk calculation unit 125 determines a TTC (Time To Collision) in accordance with a relative distance L and a relative speed V and calculates a degree of risk in accordance with the TTC. Here, the TTC is the time that supposedly elapses before a collision occurs between an object and the vehicle 300. If the object and the vehicle 300 each move at a constant speed, a TTC may be calculated in accordance with the following formula (3).

TTC=relative distance/relative speed (3)

To calculate a TTC for the X direction and the Y direction, the degree-of-risk calculation unit 125 first obtains relative distances Lx and Ly and relative speeds Vx and Vy from the relative information DB 132. The degree-of-risk calculation unit 125 calculates the X-direction TTCx and the Y-direction TTCy in accordance with the formula (3). Next, the degree-of-risk calculation unit 125 reads, from the various-correspondence-table DB 135, the correspondence table indicating the correspondence between TTCs and degrees of risk, and compares the TTCx and TTCy with the correspondence table to calculate the degree of risk.

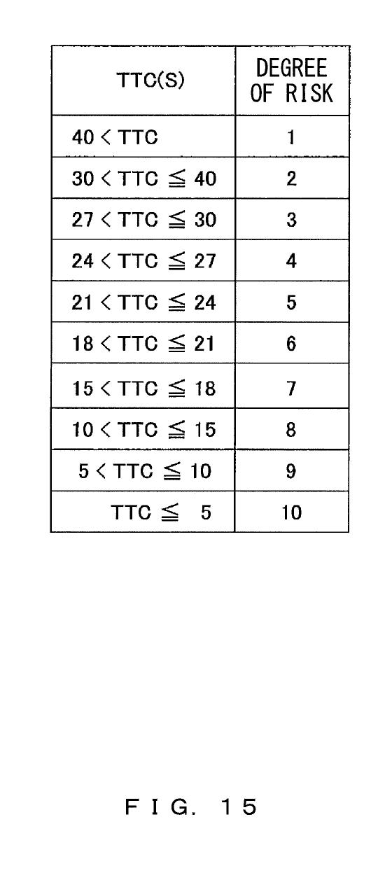

FIG. 15 illustrates an example of a correspondence table indicating a relationship between TTCs and the degrees of risk. In FIG. 15, TTCs are classified into ten levels in accordance with, for example, the degree of risk. As an example, the degree-of-risk calculation unit 125 determines that the X-direction degree of risk is three when the TTCx is thirty seconds and determines that the Y-direction degree of risk is nine when the TTCy is six seconds. In addition, the degree-of-risk calculation unit 125 may set the degree of risk of each of the TTCx and TTCy as the degree of risk of an object, or, as an example, the degree-of-risk calculation unit 125 may set the X-direction degree of risk or the Y-direction degree of risk, whichever is higher, as the degree of risk of the object in the current frame.

The degree-of-risk calculation unit 125 calculates a TTC in accordance with the formula (3) on the assumption that an object and the vehicle 300 each move at a constant speed, but the TTC may be calculated in further consideration of, for example, a relative acceleration.

The degree-of-risk calculation unit 125 stores the calculation results above in the diagnosis result DB 134, which will be described hereinafter.

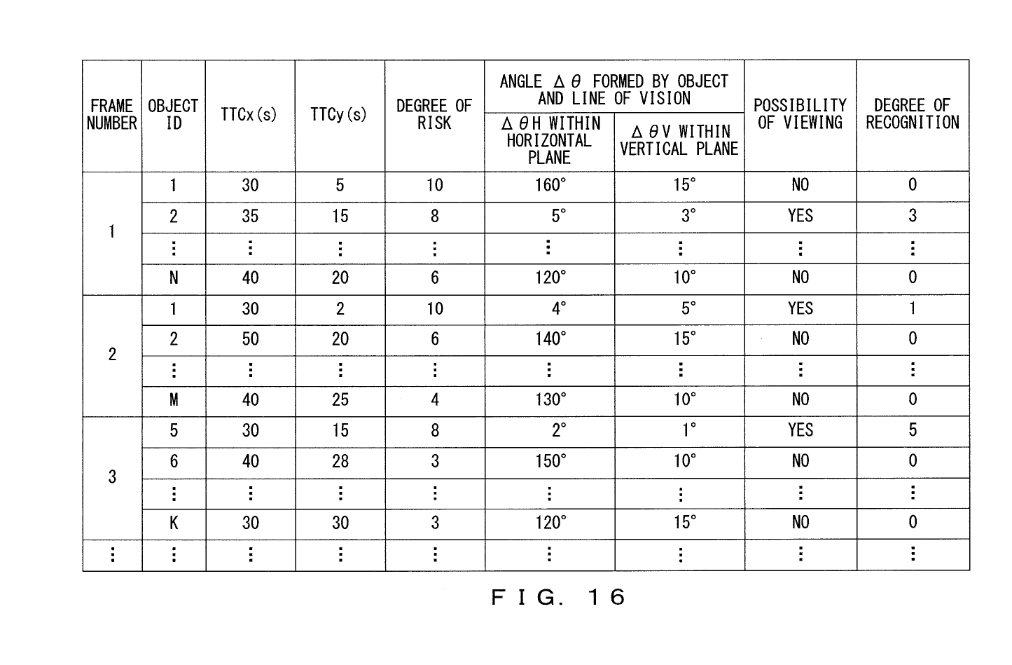

FIG. 16 illustrates an example of a diagnosis result DB. For each frame and each object, the diagnosis result DB 134 stores a TTCx, a TTCy, and a degree of risk calculated by the degree-of-risk calculation unit 125. In addition, the diagnosis result DB 134 stores, for example, determination results of the line-of-vision determination unit 126 and diagnosis results of the degree-of-recognition diagnosis unit 127, and these results will be described hereinafter. The determination results of the line-of-vision determination unit 126 include the line-of-vision vector 150a or the mirror line-of-vision vector 155a, the object vector 160a, the formed angles ΔθH and ΔθV, and the presence/absence of the viewing. The diagnosis results of the degree-of-recognition diagnosis unit 127 include the degree of recognition of the driver of the vehicle 300 with respect to an object.

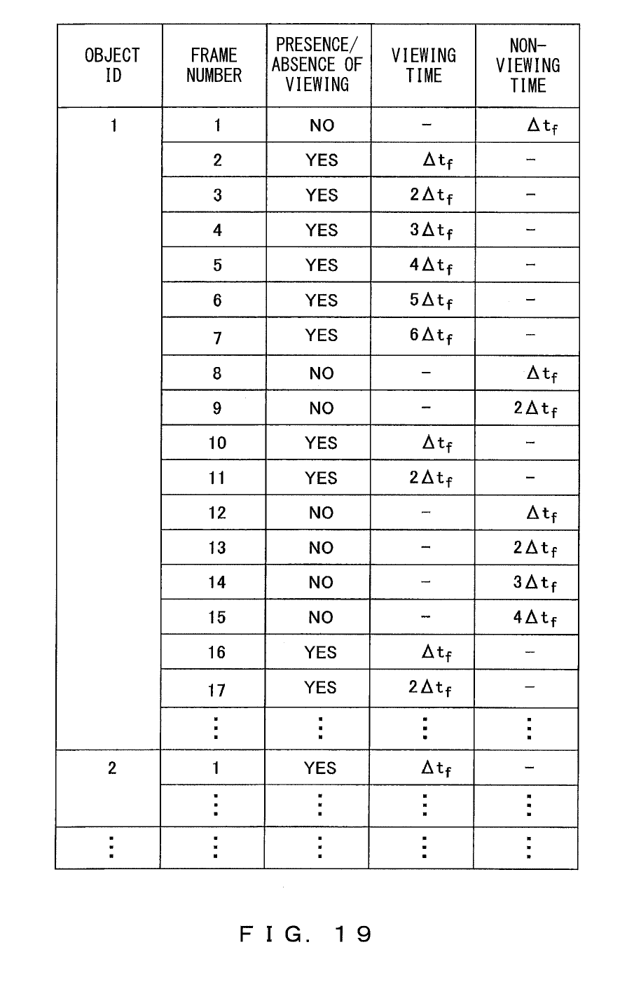

The diagnosis result DB 134 further stores the calculation results of the calculation of viewing times and non-viewing times in FIG. 19, and these times will be described hereinafter.

(4-2-8) Line-of-Vision Determination Unit

The line-of-vision determination unit 126 determines whether or not the line-of-vision vector 150a is on the mirror 303 in accordance with the line-of-vision origin P and the line-of-vision vector 150a obtained from the information obtainment apparatus 200. Here, assume that the line-of-vision determination unit 126 grasps the regions of the mirror planes, i.e., the regions of the left-side door mirror 303L, the right-side door mirror 303R, and the back mirror 303B of the vehicle 300, by obtaining the information from, for example, the information obtainment apparatus 200. The regions of the mirror planes are the regions of the reflection planes which reflect incident light, and they are defined by a coordinate set which is based on, for example, the spatial coordinate system. The line-of-vision determination unit 126 determines whether the line-of-vision vector 150a is on the mirror 303 or not in accordance with whether the region of the mirror plane and the line-of-vision vector 150a extending from the line-of-vision origin P intersect with each other.

When the line-of-vision vector 150a and the region of the mirror plane intersect with each other, the line-of-vision determination unit 126 sets the intersection as the mirror line-of-vision origin R. In addition, the line-of-vision determination unit 126 determines the mirror line-of-vision vector 155a by causing the line-of-vision vector 150a to be reflected from the mirror 303 in such away that the line-of-vision vector 150a extends from the mirror line-of-vision origin R. The line-of-vision determination unit 126 stores the presence/absence of the viewing of the mirror 303, the mirror line-of-vision origin R, and the mirror line-of-vision vector 155a in the line-of-vision data DB 133 as illustrated in FIG. 11 described above. When the positions of the mirrors 303 are changed due to fine adjustment or the like, the line-of-vision determination unit 126 obtains the regions of the mirror planes after the change from, for example, the information obtainment apparatus 200.

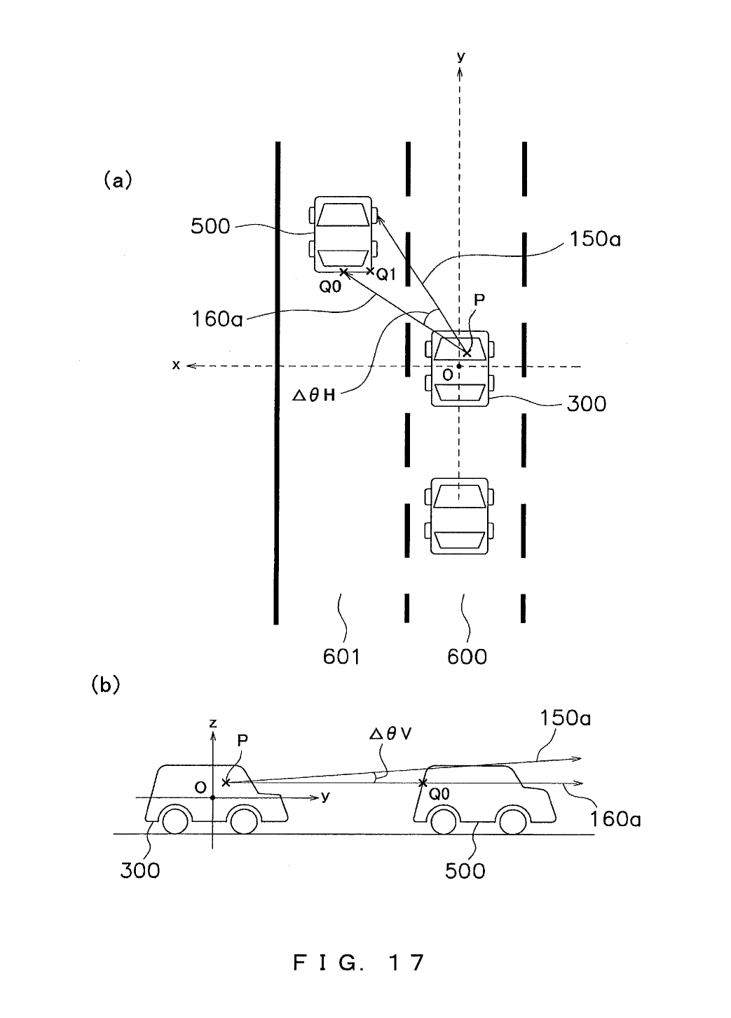

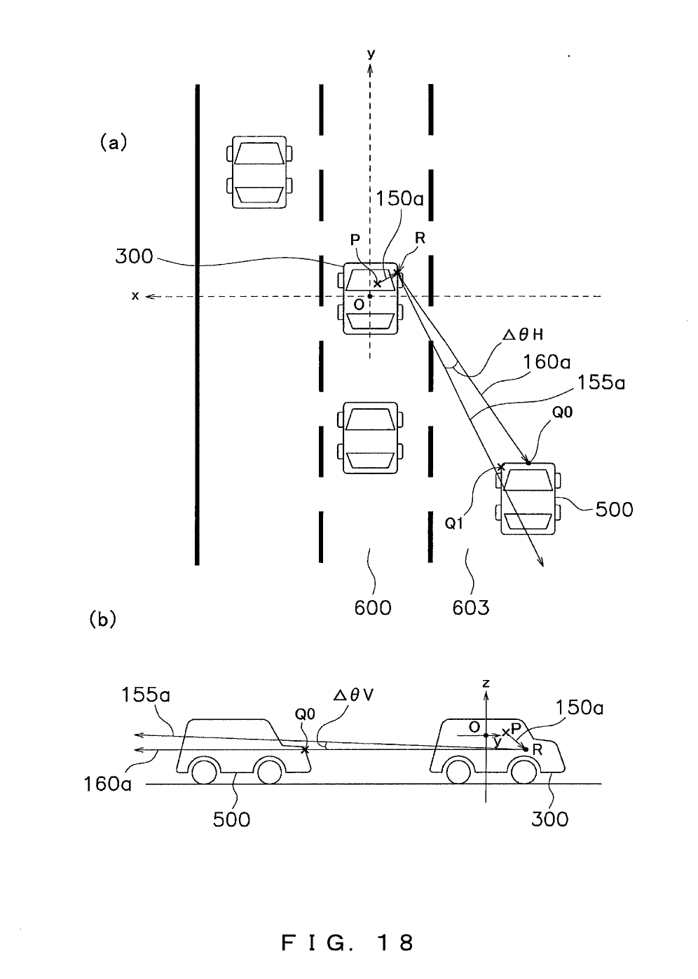

The line-of-vision determination unit 126 also establishes the line-of-vision space 151 centered around the line of vision 150 of the driver of the vehicle 300, and it determines whether or not at least one region of an object is included in the line-of-vision space 151, thereby determining the presence/absence of the viewing. Here, the line-of-vision determination unit 126 determines whether or not the driver is viewing the object in accordance with the angle Δθ formed by the object vector 160a and the line-of-vision vector 150a or the mirror line-of-vision vector 155a. The determination method will be described in the following using FIGS. 17 and 18.

FIG. 17 is an explanatory diagram illustrating an example of a method for determining viewing in accordance with an angle Δθ formed by a line-of-vision vector and an object vector. The vehicle 300 is running on the lane 600, and the other vehicle 500, which is an object, is running on the lane 601, which is to the left of and adjacent to the lane 600. The other vehicle 500 is to the left of and ahead of the vehicle 300. The line-of-vision determination unit 126 refers to the line-of-vision data DB 133, and, when the line-of-vision determination unit 126 determines that the viewing of the mirror is the judgment of “NO” in a determination-target frame, it reads the line-of-vision origin P and the line-of-vision vector 150a. The line-of-vision determination unit 126 also refers to the relative information DB 132 and reads the object vector 160a for the determination-target frame and the determination-target object. Next, the line-of-vision determination unit 126 calculates the angle Δθ formed by the driver's line-of-vision vector 150a extending from the line-of-vision origin P and the object vector 160a extending from the line-of-vision origin P. Here, the line-of-vision determination unit 126 calculates the angle ΔθH formed by the line-of-vision vector 150a and the object vector 160a within the XY plane, as illustrated in FIG. 17(a). In addition, the line-of-vision determination unit 126 calculates the angle ΔθV formed by the line-of-vision vector 150a and the object vector 160a within the YZ plane, as illustrated in FIG. 17(b).

Next, the line-of-vision determination unit 126 compares the calculated Δθ with predetermined thresholds θth for determining whether or not the driver is viewing an object, thereby determining whether or not the driver is viewing the object. The thresholds θth include a predetermined threshold θHth for determining the angle Δθ formed within the XY plane and a predetermined threshold θVth for determining the angle ΔθV formed within the YZ plane. Accordingly, the line-of-vision determination unit 126 determines whether the formed angle ΔθH is less than or equal to the predetermined threshold θHth, and, in addition, it determines whether the formed angle ΔθV is less than or equal to the predetermined threshold θVth. When the formed angle ΔθH is less than or equal to the predetermined threshold θHth and the formed angle ΔθV is less than or equal to the predetermined threshold θVth, the line-of-vision determination unit 126 determines that the driver of the vehicle 300 viewed the other vehicle 500, which is the object. Meanwhile, when the formed angle ΔθH is greater than the predetermined threshold θHth or the formed angle ΔθV is greater than the predetermined threshold θVth, the line-of-vision determination unit 126 determines that the driver did not view the other vehicle 500.

FIG. 18 is an explanatory diagram illustrating an example of a method for determining viewing in accordance with an angle Δθ formed by a mirror line-of-vision vector and an object vector. The vehicle 300 is running on the lane 600, and the other vehicle 500, which is an object, is running on the lane 603, which is to the right of and adjacent to the lane 600. The other vehicle 500 is to the right of and behind the vehicle 300. The line-of-vision determination unit 126 refers to the line-of-vision data DB 133, and, when the line-of-vision determination unit 126 determines that the viewing of the mirror is the judgment of “YES” in a determination-target frame, it reads the mirror line-of-vision origin R and the mirror line-of-vision vector 155a. As an example, assume that the driver is viewing the right-side door mirror 303R of the vehicle 300. Accordingly, as illustrated in FIG. 18, the line-of-vision vector 150a extending from the line-of-vision origin P is reflected from the mirror 303R and thus has turned into the mirror line-of-vision vector 155a extending from the mirror line-of-vision origin R. The line-of-vision determination unit 126 also refers to the relative information DB 132 and reads the object vector 160a for the determination-target frame and the determination-target object. The line-of-vision determination unit 126 calculates the angle Δθ formed by the mirror line-of-vision vector 155a extending from the mirror line-of-vision origin R and the object vector 160a extending from the mirror line-of-vision origin R. That is, the line-of-vision determination unit 126 calculates the angle ASH formed within the XY plane by the mirror line-of-vision vector 155a and the object vector 160a and the angle ΔθV formed within the YZ plane by the mirror line-of-vision vector 155a and the object vector 160a, as illustrated in FIGS. 18 (a) and (b). In addition, by comparing the formed angle ΔθH and ΔθV with the thresholds θHth and θVth, the line-of-vision determination unit 126 determines whether or not the driver of the vehicle 300 viewed the other vehicle 500 in the mirror 303, as with the aforementioned case.

In the descriptions above, the presence/absence of the driver's viewing is determined in accordance with both ΔθH and ΔθV, but it may be determined in accordance with only one of the angles, e.g., ΔθH.

The line-of-vision determination unit 126 stores, as the determination results, the formed angles ΔθH and ΔθV and the presence/absence of the viewing in the diagnosis result DB 134.

In addition, the line-of-vision determination unit 126 may calculate a viewing time and a non-viewing time for each object, so that these frames can be used for the determination of the degree of recognition, which will be described hereinafter. FIG. 19 illustrates an example of viewing times and non-viewing times stored by the diagnosis result DB. In FIG. 19, the presence/absence of viewing in each frame is represented by YES or NO for each object ID. When an object focused on is viewed in consecutive frames, the line-of-vision determination unit 126 sums the frame times Δtf of these consecutive frames to calculate the viewing time. Also for the non-viewing time, the line-of-vision determination unit 126 calculates the non-viewing time by summing the frame times Δtf of frames in which the object is not viewed. Note that the frame time of one frame is Δtf.

As an example, the object with the object ID “1” in FIG. 19 is consecutively viewed in, for example, the six frames with the frame numbers 2 to 7, and hence, at the time of the frame number 7, the line-of-vision determination unit 126 calculates the viewing time, 6Δtf. The object is not viewed in the four frames, frames 12 to 15, and hence, at the time of the frame number 15, the line-of-vision determination unit 126 calculates the non-viewing time, 4Δtf. When the viewing and the non-viewing are switched, the line-of-vision determination unit 126 resets the viewing time and the non-viewing time.

(4-2-9) Degree-of-Recognition Diagnosis Unit

The degree-of-recognition diagnosis unit 127 diagnoses the degree of recognition of the driver of the vehicle 300 with respect to an object and stores this degree in the diagnosis result DB 134.

Here, the situation in which the driver recognizes an object indicates a situation in which the driver has information on the object, e.g., the driver recognizes where the object is, which direction the object is going in, what the object is, or the like. The degree of recognition of (or with respect to) an object is the index of the extent of recognition of the object. Simply viewing an object does not mean that the driver has the aforementioned information on the object, and hence viewing is distinguished from recognizing herein.

Various methods are available as a method for diagnosing the degree of recognition, and the degree-of-recognition diagnosis unit 127 may diagnose the degree of recognition using, for example, the following methods (i) to (vi). However, these diagnosis methods are mere examples, and hence the method for diagnosing the degree of recognition is not limited to these.

(i)

As an example, the degree-of-recognition diagnosis unit 127 diagnoses the degree of recognition in accordance with the positional relationship between the line-of-vision space 151 in FIG. 7 and the other vehicle 500, which is an object. As an example, the degree-of-recognition diagnosis unit 127 determines whether the object is positioned at the central portion of the line-of-vision space 151 or not; if the object is positioned at the central portion of the line-of-vision space, the line of vision 150 intersects with the object, and hence the degree of recognition of the object is diagnosed as being high. The degree-of-recognition diagnosis unit 127 also determines the percentage of the portion of the object which occupies the line-of-vision space 151, and, if the entire region of the object occupies the line-of-vision space 151, the degree-of-recognition diagnosis unit 127 diagnoses the degree of recognition of the object as being high. The degree-of-recognition diagnosis unit 127 stores in advance the relationship between the degree of recognition and the position of an object relative to the line-of-vision space 151, the relationship between the degree of recognition and the rate of an object included in the line-of-vision space 151, and the like.

(ii)

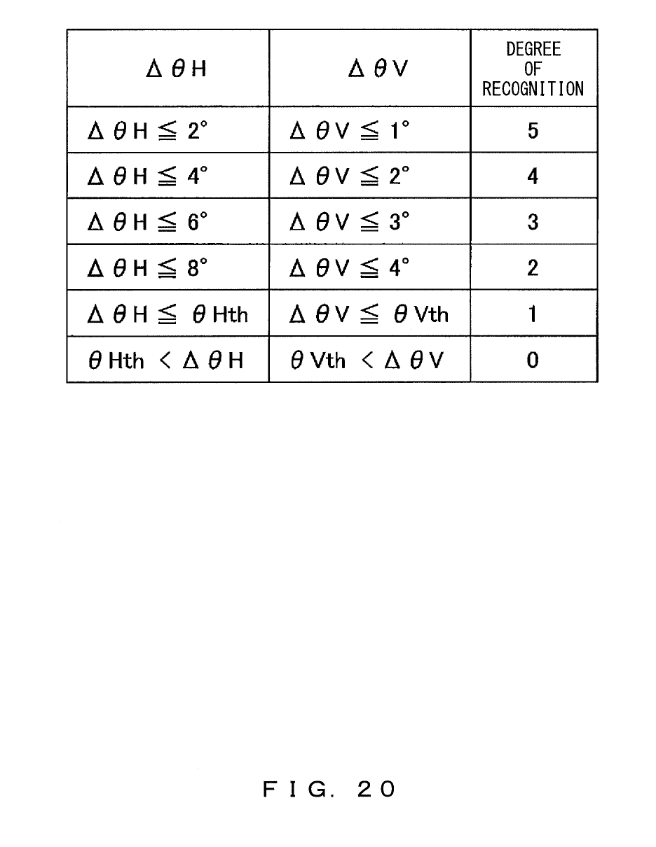

As an example, the degree-of-recognition diagnosis unit 127 diagnoses the degree of recognition in accordance with the angle Δθ formed by the object vector 160a and the line-of-vision vector 150a or the mirror line-of-vision vector 155a. FIG. 20 illustrates an example of a correspondence table indicating a relationship between formed angles ΔθH and ΔθV and the degrees of recognition. The degrees of recognition, divided into six levels 0 to 6, correspond to predetermined ranges of ΔθH and ΔθV. The degree-of-recognition diagnosis unit 127 obtains ΔθH and ΔθV from the diagnosis result DB 134 and refers to the correspondence table in FIG. 20 to diagnose the degree of recognition.

When, for example, ΔθH is 0° and ΔθV is 1°, the degree-of-recognition diagnosis unit 127 diagnoses the degree of recognition as the highest level “5”. In this case, the driver's line of vision 150 is directed directly to the object, and hence it is thought to be certain that the driver is viewing the object. When the degree of recognition based on ΔθH and that based on ΔθV are different from each other, the degree-of-recognition diagnosis unit 127 will determine the degree of recognition in accordance with the lower level. As an example, when the degree of recognition based on the ΔθH, 5°, is 5 and the degree of recognition based on the ΔθV, 1, is 3, the degree of recognition may be diagnosed as “3”. Meanwhile, when the formed angle ΔθH is greater than a predetermined threshold θHth or the formed angle ΔθV is greater than a predetermined threshold θVth, the degree-of-recognition diagnosis unit 127 diagnoses the degree of recognition as the lowest level “0”.

(iii)

If an object is viewed only for an instant, a short viewing time, the driver cannot recognize the object. Accordingly, the degree-of-recognition diagnosis unit 127 diagnoses the degree of recognition in accordance with the length of the viewing time. Here, the various-correspondence-table DB 135 stores a correspondence table indicating the correspondence between the lengths of viewing times and the degrees of recognition, and, in this correspondence table, a higher degree of recognition is set for example, as the viewing time becomes longer. The degree-of-recognition diagnosis unit 127 reads a viewing time from the diagnosis result DB 134 and diagnoses the degree of recognition in accordance with the correspondence table.

(iv)

If the non-viewing time for an object is long, the driver cannot recognize the object. Accordingly, the degree-of-recognition diagnosis unit 127 diagnoses the degree of recognition in accordance with the length of the non-viewing time. Here, the various-correspondence-table DB 135 stores a correspondence table indicating the correspondence between the lengths of non-viewing times and the degrees of recognition, and, in this correspondence table, a lower degree of recognition is set for example, as the non-viewing time becomes longer. The degree-of-recognition diagnosis unit 127 reads a non-viewing time from the diagnosis result DB 134 and diagnoses the degree of recognition in accordance with the correspondence table.

The degree-of-recognition diagnosis unit 127 may diagnose the degree of recognition in accordance with both the viewing time and the non-viewing time. As an example, even if the degree-of-recognition diagnosis unit 127 initially diagnoses the degree of recognition as a high level in accordance with a long viewing time, the degree-of-recognition diagnosis unit 127 diagnoses the degree of recognition as a low level in accordance with the non-viewing time if the non-viewing time is long after the viewing time.

The degree-of-recognition diagnosis unit 127 may diagnose the degree of recognition of each object in accordance with whether or not the non-viewing time is shorter than the TTC which supposedly elapses before a collision occurs between each object and the vehicle.

When the non-viewing time for an object is equal to the TTC or longer, the vehicle and the object may collide with each other. Accordingly, when the non-viewing time is equal to the TTC or longer, the degree-of-recognition diagnosis unit 127 diagnoses as small the degree of recognition of the object. Meanwhile, when the non-viewing time is shorter than the TTC, the degree-of-recognition diagnosis unit 127 diagnoses as large the degree of recognition of the object.

The degree-of-recognition diagnosis unit 127 may diagnose the degree of recognition in accordance with the moving speed of the line of vision 150 moving between a plurality of line-of-vision spaces 151. As an example, when the moving speed is equal to a predetermined value Va or greater, the degree-of-recognition diagnosis unit 127 diagnoses the degree of recognition as large, and when the moving speed is less than the predetermined value Va, the degree-of-recognition diagnosis unit 127 diagnoses the degree of recognition as small.

(v)

The degree-of-recognition diagnosis unit 127 may diagnose the degrees of recognition of a plurality of objects in accordance with a viewing frequency indicating the proportion of the length of the viewing time for each of the objects within a predetermined time period Ta. The diagnosis apparatus may diagnose the degrees of recognition of a plurality of objects in accordance with a viewing interval for each of the objects which indicates the intervals between the viewings of the objects.

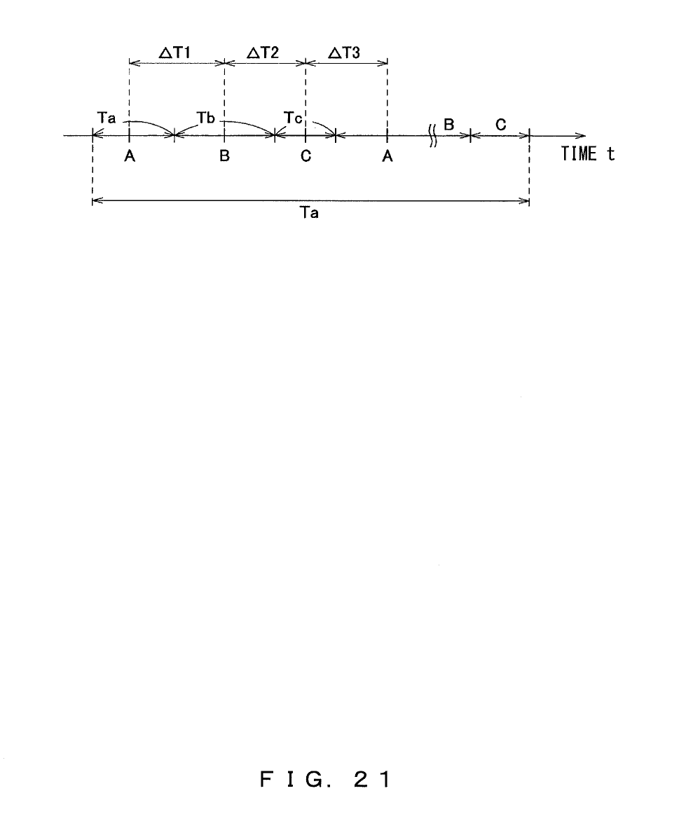

FIG. 21 is an explanatory diagram illustrating a method for diagnosing the degree of recognition in accordance with a viewing frequency or a viewing interval. Objects A, B and C are extracted, and the driver of the vehicle 300 views the objects A to C alternately. In FIG. 21, viewing times ta, tb and tc are indicated on the temporal axis t for the objects A to C, respectively. The degree-of-recognition diagnosis unit 127 measures the viewing frequency of the viewing of each of the objects A to C within the predetermined time period Ta. As an example, the degree-of-recognition diagnosis unit 127 diagnoses the degree of recognition as higher, as the viewing frequency of the viewing of each object becomes higher.

The degree-of-recognition diagnosis unit 127 calculates viewing intervals ΔT1, ΔT2 and ΔT3 between the viewings of the objects A to C and diagnoses the degree of recognition in accordance with the viewing intervals ΔT1, ΔT2 and ΔT3. As an example, the degree-of-recognition diagnosis unit 127 diagnoses the degree of recognition in accordance with whether or not the viewing intervals ΔT1, ΔT2 and ΔT3 are appropriate to enable the viewings of the objects A to C. A viewing interval is calculated by, for example, the time period between the midpoints of viewing times.

In this way, the diagnosis apparatus 100 may diagnose whether the driver is recognizing a plurality of objects.

(vi)

The degree-of-recognition diagnosis unit 127 may diagnose the driver's degree of recognition in accordance with the ratio between the number of objects around the vehicle 300 and the number of objects judged to be viewed from among those around the vehicle 300. The overall degree of recognition of a plurality of objects around the vehicle 300 may be diagnosed.

(4-2-10) Diagnosis Result Output Unit

The diagnosis result output unit 128 obtains the degree of recognition of each object in the current frame from the diagnosis result DB 134 and outputs it to output devices such as the display 105 and the speaker 106.

The diagnosis result output unit 128 may compare a predetermined value with the degree of recognition obtained from the diagnosis result DB 134 to output information on an object corresponding to the degree of recognition which is equal to the predetermined value or lower. Information on an object includes, for example, the degree of recognition, the degree of risk of a collision, and the TTC. Objects corresponding to the degree of recognition which is equal to the predetermined value or lower include an object corresponding to a short viewing time and an object which is not included in the line-of-vision space, namely, and object which is not viewed. Upon reception of information on an object, the driver may obtain information indicating that the degree of recognition is low in spite of a high risk of a collision, and hence she/he may improve the driving appropriately.

(4-2-11) Various-Correspondence-Table DB 135

The various-correspondence-table DB 135 stores the correspondence between each pixel of each of the cameras 205a to 205d and each coordinate of the three-dimensional plane of projection 400.

The various-correspondence-table DB 135 stores a correspondence table indicating the relationship between TTCs and the degrees of risk indicated in FIG. 15, and a correspondence table indicating the relationship between the formed angles ΔθH and ΔθV and the degrees of recognition indicated in FIG. 20. In addition, the various-correspondence-table DB 135 stores, for example, a correspondence table indicating the correspondence between the degrees of recognition and viewing times or non-viewing times.

(5) Process Flow

The flow of processes performed by the diagnosis apparatus in accordance with the first embodiment will be described in the following. The entire process flow will be described first, and the flow of each of the processes forming the entire process will be described then.

(5-1) Entire Process

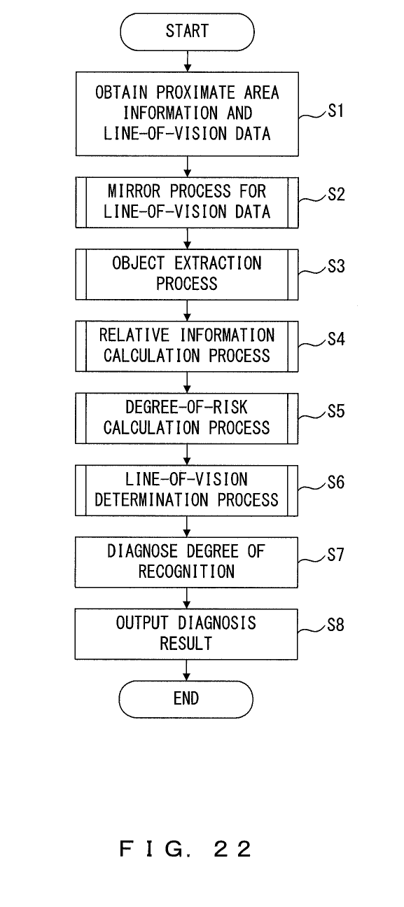

FIG. 22 is a flowchart illustrating an example of the flow of the entire process performed by the diagnosis apparatus in accordance with the first embodiment. The entire process is performed for each frame.

Step S1: The diagnosis apparatus 100 obtains, from the information obtainment apparatus 200, proximate area information and line-of-vision data including a line-of-vision origin P and a line-of-vision vector 150a and stores these pieces of data in the proximate area information DB 131 and the line-of-vision data DB 133, respectively.

Step S2: In accordance with whether the driver is viewing the mirror or not, the line-of-vision determination unit 126 performs the mirror process for the line-of-vision data.

Step S3: The image processing unit 122 generates a proximate area image of an area proximate to the vehicle 300 in accordance with the proximate area information, and the object extraction unit 123 extracts, from the proximate area image, one or more objects around the vehicle 300.

Step S4: The relative information calculation unit 124 calculates relative information such as a relative distance L and a relative speed V between the vehicle 300 and the one or more objects and an object vector 160a indicating the direction of an object relative to the vehicle 300.

Step S5: The degree-of-risk calculation unit 125 calculates the degree of risk of a collision between the object and the vehicle 300 in accordance with, for example, relative information within the relative information DB 132.

Step S6: The line-of-vision determination unit 126 determines whether or not the driver is viewing the object, in accordance with the angle Δθ formed by the object vector 160a and the line-of-vision vector 150a or the mirror line-of-vision vector 155a.

Step S7: The degree-of-recognition diagnosis unit 127 diagnoses the degree of recognition of the driver of the vehicle 300 with respect to the object and stores this degree in the diagnosis result DB 134.

Step S8: For each object within the current frame, the diagnosis result output unit 128 outputs information, including, for example, the degree of recognition, degree of risk of a collision, and/or TTC, to an output device such as the display 105 or the speaker 106.

(5-2) Mirror process for Line-of-Vision Data

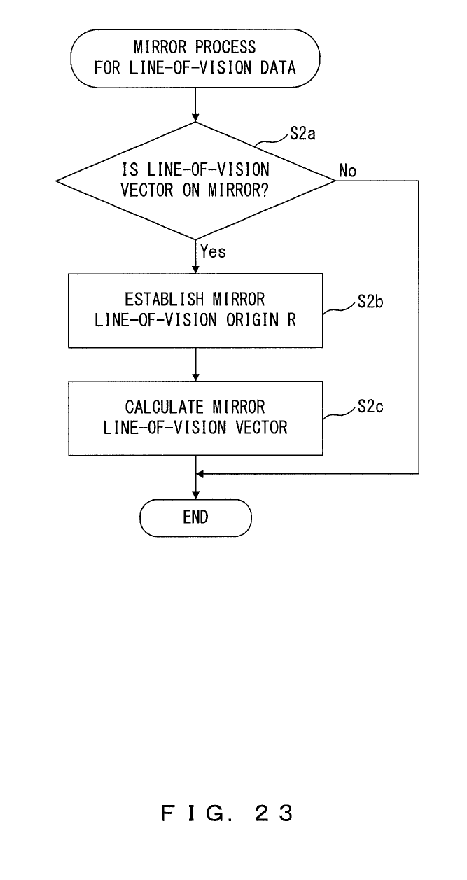

FIG. 23 is a flowchart illustrating an example of the flow of a mirror process for line-of-vision data in accordance with the first embodiment. The flow of the mirror process for line-of-vision data included in the entire process described above will be described in the following.

Step S2a: In accordance with the line-of-vision origin P and the line-of-vision vector 150a, the line-of-vision determination unit 126 determines whether the line-of-vision vector 150a is on the mirror 303 or not. The process proceeds to step S2b when the line-of-vision vector 150a is on the mirror 303; otherwise, the process is terminated.

Steps S2b and S2c: The line-of-vision determination unit 126 establishes a mirror line-of-vision origin R (S2b) and calculates a mirror line-of-vision vector 155a (S2c).

(5-3) Object Extraction Process

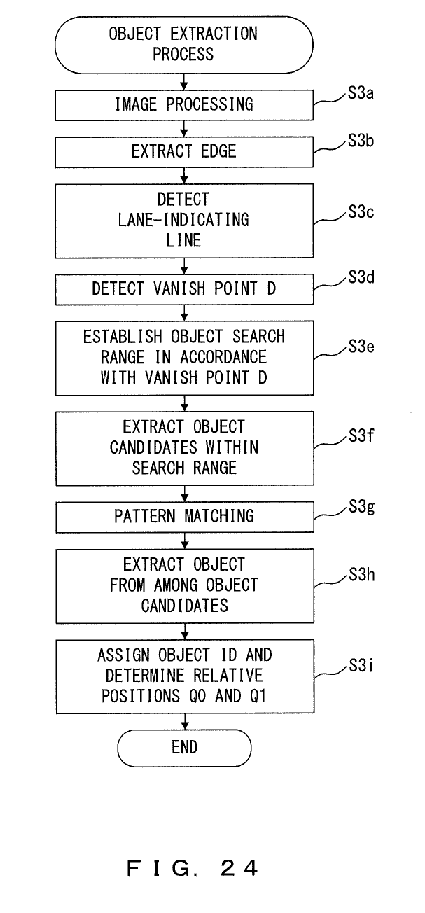

FIG. 24 is a flowchart illustrating an example of the flow of an object extraction process in accordance with the first embodiment.

Step S3a: The image processing unit 122 projects image data of each of the cameras 205a to 205d onto the three-dimensional plane of projection 400 to generate a proximate area image.

Steps S3b and S3c: The object extraction unit 123 extracts edges in the proximate area image generated by the image processing unit 122 (S3d) and detects the lane-indicating lines 602a to 602d (S3c).

Steps S3d and S3e: Next, the object extraction unit 123 detects a vanishing point D from the intersection between the lane-indicating lines 602a to 602d (S3d) and establishes an object search range in accordance with the vanishing point D (S3e).

Step S3f: The object extraction unit 123 extracts object candidates from the search range.

Steps S3g and S3h: The object extraction unit 123 performs the pattern matching of the object candidates (S3g) and extracts an object (S3h).

Step S3i: The object extraction unit 123 assigns an ID to the extracted object, obtains relative positions Q0 and Q1 of the object relative to the vehicle 300, and stores them in the relative information DB 132.

(5-4) Relative Information Calculation Process

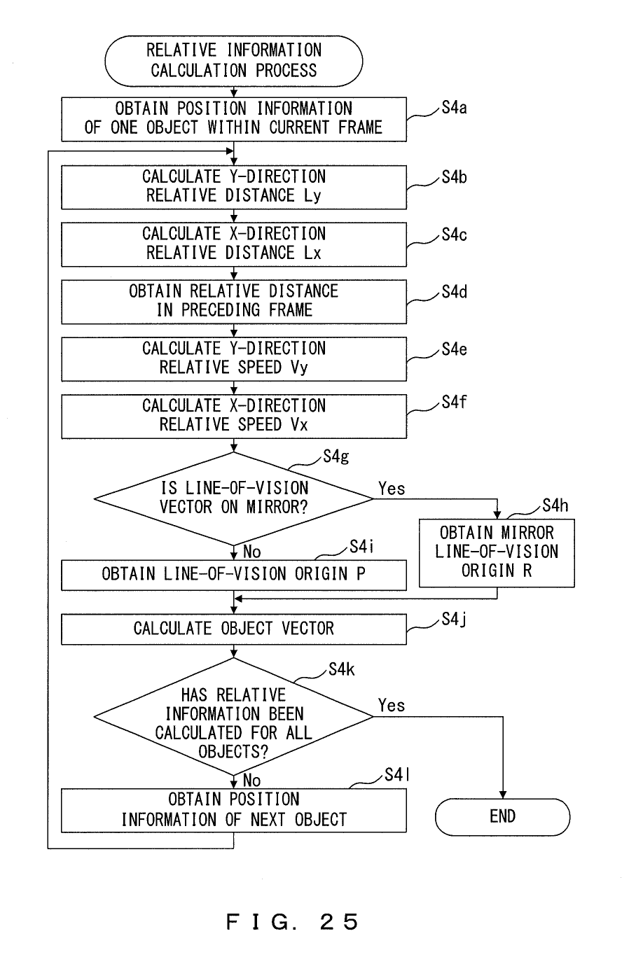

FIG. 25 is a flowchart illustrating an example of the flow of a relative information calculation process in accordance with the first embodiment.

Step S4a: The relative information calculation unit 124 selects one object within the current frame and obtains the position information from the relative information DB 132. The position information includes the relative positions Q0 and Q1 of the object relative to the vehicle 300.

Steps S4b and S4c: In accordance with the distance between the central point O of the vehicle 300 and the relative position Q1 of the object, the relative information calculation unit 124 calculates the Y-direction relative distance Ly (S4b) and the X-direction relative distance Lx (S4c).

Step S4d: Next, the relative information calculation unit 124 obtains the relative positions Ly and Lx of the aforementioned one object within the preceding frame immediately preceding the current frame.

Steps S4e and S4f: In accordance with the difference between the relative distance L in the current frame and that in the preceding frame and the time period between these frames, the relative information calculation unit 124 calculates the Y-direction relative speed Vy and the X-direction relative speed Vx.

Step S4g: The relative information calculation unit 124 determines whether the line-of-vision vector 150a is on the mirror 303 and whether the driver of the vehicle 300 is viewing the mirror.

Step S4h: When the line-of-vision vector 150a is on the mirror 303, the relative information calculation unit 124 obtains the mirror line-of-vision origin R from the line-of-vision data DB 133.

Step S4i: Meanwhile, when the driver is not viewing the mirror, the relative information calculation unit 124 obtains the line-of-vision origin P from the line-of-vision data DB 133.

Step S4j: The relative information calculation unit 124 calculates the object vector 160a indicating the direction 160 from the line-of-vision origin P or the mirror line-of-vision origin R toward the object.

Steps S4k and S41: When the relative information calculation unit 124 completes the calculation of relative information for all objects within the current frame (S4k), the process is finished. Otherwise, the next object is selected and the position information is obtained (S41), and the process returns to step S4b.

(5-5) Degree of Risk Calculation Process

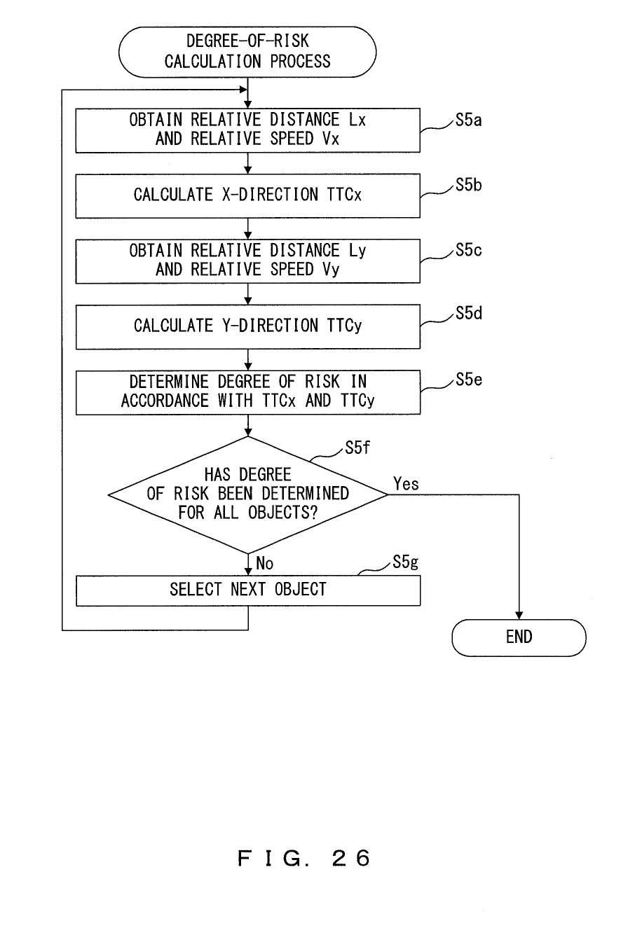

FIG. 26 is a flowchart illustrating an example of the flow of a degree-of-risk calculation process in accordance with the first embodiment.

Step S5a: The degree-of-risk calculation unit 125 obtains the X-direction relative distance Lx and relative speed Vx from the relative information DB 132.

Step S5b: In accordance with the X-direction relative distance Lx and relative speed Vx, the degree-of-risk calculation unit 125 calculates the TTCx that supposedly elapses before the vehicle 300 and an object collide with each other at a position oriented in the X direction from the vehicle 300.

Steps S5c and S5d: In accordance with the Y-direction relative distance Ly and relative speed Vy obtained from the relative information DB 132 (S5c), the degree-of-risk calculation unit 125 calculates the TTCy that supposedly elapses before the vehicle 300 and the object collide with each other at a position oriented in the Y direction from the vehicle 300 (S5d).

Step S5e: The degree-of-risk calculation unit 125 calculates the degree of risk respectively for the X direction and the Y direction in accordance with the TTCx and the TTCy, and it regards the higher one of these degrees of risk as being the degree of risk for the current frame.

Steps S5f and S5g: When the degree-of-risk calculation unit 125 completes the calculation of the degrees of risk for all objects within the current frame (S5f), the process is finished. Otherwise, the next object is selected (S5g), and the process returns to step S5a.

(5-6) Line-of-Vision Determination Process

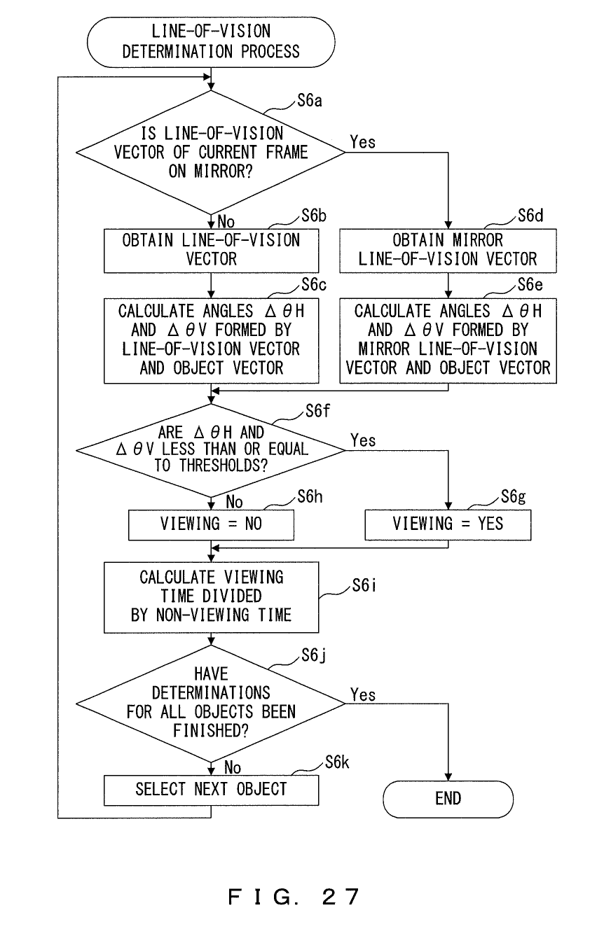

FIG. 27 is a flowchart illustrating an example of the flow of a line-of-vision determination process in accordance with the first embodiment.

Step S6a: The line-of-vision determination unit 126 refers to the line-of-vision data DE 133 to determine whether or not the mirror 303 is viewed in the current frame in accordance with whether the line-of-vision vector is on the mirror 303 or not. The process proceeds to step S6d when the mirror 303 is being viewed, otherwise it proceeds to step S6b.

Step S6b: When the mirror 303 is not being viewed, the line-of-vision determination unit 126 reads the line-of-vision origin P and the line-of-vision vector 150a from the line-of-vision data DE 133.

Step S6c: The line-of-vision determination unit 126 selects a determination-target object and reads the object vector 160a from the relative information DB 132. Next, the line-of-vision determination unit 126 calculates the angles ΔθH and ΔθV formed by the line-of-vision vector 150a extending from the line-of-vision origin P and the object vector 160a extending from the line-of-vision origin P.

Step S6e: When the mirror 303 is being viewed, the line-of-vision determination unit 126 reads the mirror line-of-vision origin R and the mirror line-of-vision vector 155a from the line-of-vision data DB 133.

Step S6e: The line-of-vision determination unit 126 selects a determination-target object and reads the object vector 160a from the relative information DB 132. Next, the line-of-vision determination unit 126 calculates the angles ΔθH and ΔθV formed by the mirror line-of-vision vector 155a extending from the line-of-vision origin R and the object vector 160a extending from the mirror line-of-vision origin R.

Step S6f: The line-of-vision determination unit 126 determines whether or not the formed angles ΔθH and ΔθV are equal to or smaller than the thresholds θHth and θVth.

Step S6g: When the formed angle ΔθH is equal to or smaller than the predetermined threshold θHth and the formed angle ΔθV is equal to or smaller than the predetermined threshold θVth, the line-of-vision determination unit 126 determines that the driver of the vehicle 300 viewed the object.

Step S6h: Meanwhile, when the formed angle ΔθH is greater than the predetermined threshold θHth or the formed angle ΔθV is greater than the predetermined threshold θVth, the line-of-vision determination unit 126 determines that the driver did not view the object.

Step S6i: In addition, the line-of-vision determination unit 126 calculates a viewing time and a non-viewing time for each object.

Steps S6j and S6k: When the aforementioned determination is finished for all objects in the current frame (S6j), the degree-of-risk calculation unit 125 finishes the process. Otherwise, the degree-of-risk calculation unit 125 selects the next object (S6k), and the process returns to step S6a.

The diagnosis apparatus 100 in accordance with the aforementioned embodiment may diagnose the degree of recognition of an object around the vehicle 300 in accordance with the positional relationship between the object and the direction of the actual line of vision of the driver of the vehicle 300, thereby enhancing the accuracy for diagnosing the degree of recognition.

(6) Modifications

Modifications of the present embodiment will be described in the following.

(6-1) Modification 1

In the embodiment described above, the diagnosis apparatus 100 extracts objects in accordance with pattern data storing various characteristics of various objects, and it diagnoses the degrees of recognition of the extracted objects irrespective of the degree of risk. However, the diagnosis apparatus 100 may diagnose the degree of recognition of only a hazardous object from among the extracted objects, wherein the hazardous object is an object indicating a degree of risk that is equal to a predetermined value or greater.

As an example, the line-of-vision determination unit 126 refers to the diagnosis result DB 134 in FIG. 16, selects a hazardous object indicating a degree of risk that is equal to a predetermined value or greater and that has a high possibility of a collision occurrence, and determines whether the driver is viewing the hazardous object or not. The degree-of-recognition diagnosis unit 127 diagnoses the degree of recognition of the hazardous object. The method for determining the presence/absence of the viewing and the method for determining the degree of recognition are similar to those in the aforementioned embodiment.

Objects include an object having a low degree of risk of a collision with the vehicle, e.g., another vehicle moving away from the vehicle. In accordance with the aforementioned configuration, it is possible to selectively diagnose the degree of recognition of a hazardous object having a high possibility of a collision occurrence from among a plurality of objects.

When, for example, the risk is reported to the driver of the vehicle 300, it is more necessary to report the information on an object indicating a higher degree of risk of a collision occurrence than to report the information on the one indicating a lower degree of risk. In accordance with the aforementioned configuration, the degree of recognition of a hazardous object with a significant need to be reported from among objects may be selectively diagnosed.

(6-2) Modification 2

In the aforementioned embodiment, the diagnosis apparatus 100 extracts one or more objects around the vehicle 300 from a proximate area image generated by the image processing unit 122. The diagnosis apparatus 100, however, may detect an object using, for example, an obstacle detection sensor attached to the vehicle 300. The obstacle detection sensor is embedded in, for example, the front bumper or rear bumper of the vehicle 300 and detects the distance to an obstacle, and it may be configured with, for example, an optical sensor or an ultrasonic sensor. The object extraction unit 123 of the diagnosis apparatus 100 detects an object around the vehicle 300 in accordance with a sensor signal detected by such obstacle detection sensors and obtains, for example, relative positions Q0 and Q1 of the object relative to the vehicle 300. The relative information calculation unit 124 calculates, for example, a relative distance L, a relative speed V, and an object vector 160a in accordance with the sensor signal.

The diagnosis apparatus 100 may detect an object in accordance with the communication between the vehicle 300 and the object. The communication may be, for example, a vehicle-to-vehicle communication, i.e., an inter-vehicle communication. The object extraction unit 123 of the diagnosis apparatus 100 detects an object around the vehicle 300 in accordance with the communication and obtains, for example, relative positions Q0 and Q1 of the object relative to the vehicle 300. The relative information calculation unit 124 calculates, for example, a relative distance L, a relative speed V, and an object vector 160a in accordance with the communication.

(6-3) Modification 3

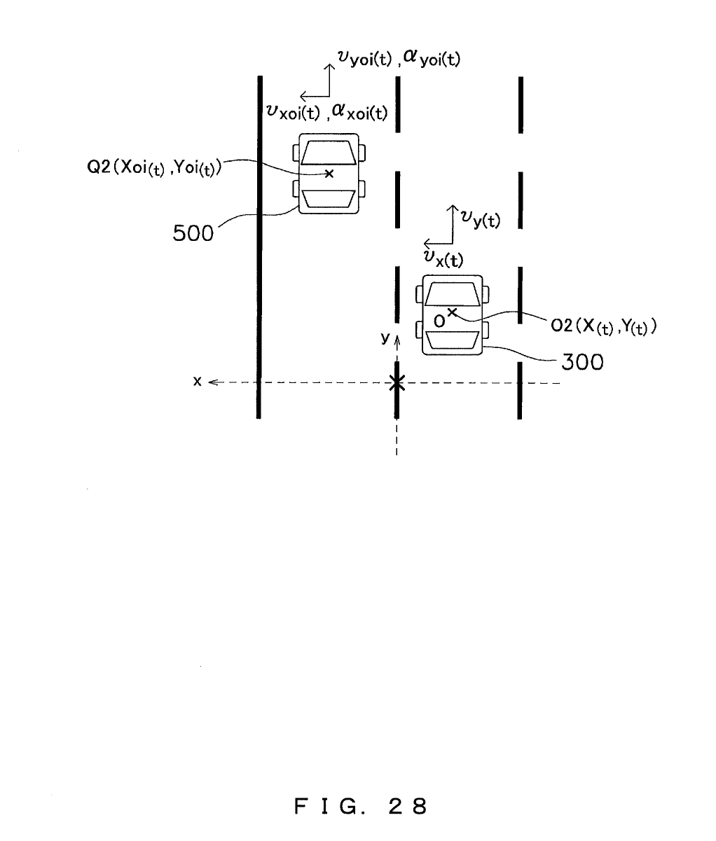

In the aforementioned embodiment, the degree-of-risk calculation unit 125 calculates a TTC in accordance with the relative distance L and the relative speed V between the vehicle 300 and an object and calculates the degree of risk in accordance with the TTC. However, the method for calculating a TTC or the degree of risk is not limited to these. As an example, in consideration of the position, speed, and acceleration of each of the vehicles 300 and the object, the TTC and the degree of risk may be calculated as follows. FIG. 28 is an explanatory diagram illustrating another method for calculating a TTC.

As an example, let the X-direction speed of the vehicle 300 at time t be Vx(t) and let the Y-direction speed be Vy(t). Vx(t) and Vy(t) may be measured by, for example, rotational speed detection sensors equipped at a right-side drive wheel and left-side drive wheel of the vehicle 300. Let the position coordinates of the vehicle 300 at time t be X (t) and Y(t). As with the case in the aforementioned embodiment, X(t) and Y(t) may be determined in accordance with a proximate area image of an area proximate to the vehicle 300. If, for example, an optional point O1 is defined as the origin, X (t) and Y(t) are represented by the coordinates of the central point O2 of the vehicle 300.

The degree-of-risk calculation unit 125 calculates the position coordinates X(t+Δt) and Y(t+Δt) of the vehicle 300 at time t+Δt from the following formulae (4) and (5).

X(t+Δt)=X(t)+Vy(t)×Δt×sin(α(t))+Vx(t)×Δt×cos(α(t)) (4)

Y(t+Δt)=Y(t)+Vy(t)×Δt×cos(α(t))−Vx(t)×Δt×sin(α(t)) (5)

Here, the acceleration is calculated from the formula, α(t)=(φ(t)+φ(t−Δt))/2, where φ indicates the steering angle of the handle 302 of the vehicle 300. The steering angle φ may be detected by, for example, a sensor at the handle 302.

Next, the degree-of-risk calculation unit 125 calculates the position coordinates Xoi(t+Δt) and Yoi(i+Δt) of the object, the other vehicle 500, at time t+Δt from the following formulae (6) and (7).

Xoi(t+Δt)=Xoi(t)+Vxoi(t)×Δt+(½)×αxoi(t)×Δt² (6)

Yoi(t+Δt)=Yoi(t)+Vyoi(t)×Δt+(½)×αyoi(t)×Δt² (7)

Here, Xoi(t) and Yoi(t) represent the position coordinates of the other vehicle 500 at time t, and they may be determined in accordance with a proximate area image of an area proximate to the vehicle 300 as in the case in the aforementioned embodiment. If the optional point O1 is defined as the origin, Xoi(t) and Yoi(t) are represented by the coordinates of the central point O2 of the other vehicle 500. Vxoi(t) and Vyoi(t) represent the X-direction speed and the Y-direction speed of the other vehicle 500 at time t, and αxoi(t) and αyoi(t) represent the X-direction acceleration and the Y-direction acceleration of the other vehicle 500 at time t. The speed and acceleration of the other vehicle 500 may be obtained, for example, by an obstacle detection sensor equipped on the vehicle 300 or through a vehicle-to-vehicle communication.

In accordance with formulae (4) and (6), the degree-of-risk calculation unit 125 calculates time TTCx that elapses before a collision occurs at a position oriented in the X direction from the vehicle 300 as the time that elapses before the coordinate X(t+Δt) of the vehicle 300 and the coordinate Xoi(t+Δt) of the object become identical with each other. Similarly, in accordance with formulae (5) and (7), the degree-of-risk calculation unit 125 calculates time TTCy that elapses before a collision occurs at a position oriented in the Y direction from the vehicle 300, as the time that elapses before the coordinate Y(t+Δt) of the vehicle 300 and the coordinate Yoi(t+Δt) of the object become identical with each other. In accordance with TTCx and TTCy calculated in this way, the diagnosis apparatus 100 calculates the degree of risk.

(6-4) Modification 4

In the aforementioned embodiment, the diagnosis apparatus 100 uses the spatial coordinate system including an optional central point O of the vehicle 300 as the origin, in order to define, for example, the line-of-vision origin P, the mirror line-of-vision origin R, and the relative positions Q0 and Q1 of an object. However, the coordinate system is not limited to this.

As an example, the diagnosis apparatus 100 may use the spatial coordinate system including the aforementioned vanishing point D as the origin, in order to define, for example, the central point O of the vehicle 300, the position of an object, the line-of-vision origin P, and the mirror line-of-vision origin R. Accordingly, the relative distance L to the object is detected in accordance with, for example, the distance between the position of the object and the coordinates of the central point O of the vehicle 300.

The number of coordinate systems is not limited to one; in other words, two coordinate systems may be used, one of which is a head coordinate system fixed by any point of the head of the driver of the vehicle 300 and the other of which is the spatial coordinate system including an optional central point O of the vehicle 300 as the origin. As an example, the diagnosis apparatus 100 uses coordinates within the head coordinate system to define line-of-vision data such as the line-of-vision origin P, the line-of-vision vector 150a, the mirror line-of-vision origin R, and the mirror line-of-vision vector 155a. Meanwhile, the diagnosis apparatus 100 defines, for example, the relative positions Q0 and Q1 of the object within the spatial coordinate system. Next, the diagnosis apparatus 100 converts the coordinates of the head coordinate system into coordinates within the spatial coordinate system to incorporate, for example, the line-of-vision origin P, the line-of-vision vector 150a, the mirror line-of-vision origin P, and the mirror line-of-vision vector 155a into the spatial coordinate system. Also through such a process, the diagnosis apparatus 100 may determine the relationship between the object vector 160a and the line-of-vision vector 150a or the mirror line-of-vision vector 155a.

(6-5) Another Modification

In the aforementioned embodiment, the diagnosis apparatus 100 calculates the object vector 160a in accordance with the line-of-vision origin P and the coordinates Q0 which are the central coordinates of one edge of the object that is the closest to the vehicle 300. However, the coordinates for calculating the object vector 160a are not limited to Q0, and, as an example, the object vector 160a may be calculated in accordance with the line-of-vision origin P and the respective midpoints of the lengthwise side and the crosswise side of the object, i.e., the coordinates of the center of the object.

In the aforementioned embodiment, the line-of-vision detection unit 222 of the information obtainment apparatus 200 calculates the line-of-vision origin P and the line-of-vision vector 150a in accordance with the image of the driver's face, eye, iris, or the like detected by the line-of-vision detection device 206. However, the line-of-vision determination unit 126 of the diagnosis apparatus 100 may calculate the line-of-vision origin P and the line-of-vision vector 150a in accordance with the image.

### [b] Second Embodiment

The diagnosis apparatus 100 in accordance with the first embodiment obtains, from the external information obtainment apparatus 200, the driver's line of vision and proximate area information on an area proximate to the vehicle. Meanwhile, a diagnosis apparatus 170 in accordance with a second embodiment obtains by itself the driver's line of vision and proximate area information on an area proximate to the vehicle 300. Differences from the first embodiment will be described in the following.

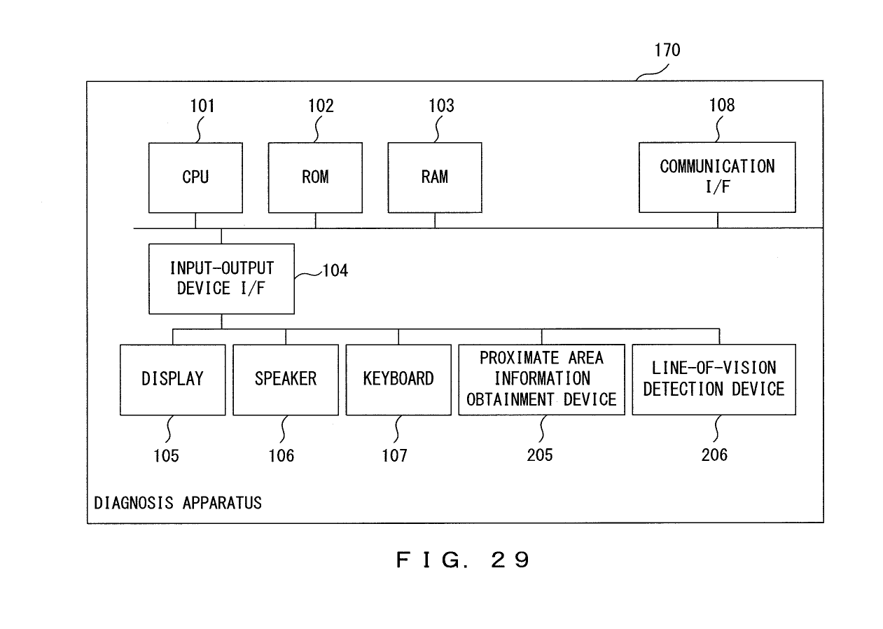

The configuration of the diagnosis apparatus 170 in accordance with the second embodiment will be described in the following. FIG. 29 illustrates an example of a block diagram indicating the hardware configuration of the diagnosis apparatus in accordance with the second embodiment.

The diagnosis apparatus 170 has, for example, a CPU 101, a ROM 102, a RAM 103, an input-output device I/F 104, and a communication I/F 108, which are connected to each other via a bus 109.

The input-output device I/F 104 is connected to input-output devices such as a display 105, a speaker 106, a keyboard 107, a proximate area information obtainment device 205 and a line-of-vision detection device 206. The proximate area information obtainment device 205 obtains proximate area information including a proximate area image of an area proximate to the vehicle 300, and the line-of-vision detection device 206 detects information on, for example, the driver's face, eyeball, or iris. These pieces of information are stored in the RAM 103. In accordance with the information obtained by the proximate area information obtainment device 205 and the line-of-vision detection device 206 within the diagnosis apparatus 170, the CPU 101 and the like of the diagnosis apparatus 170 perform processes similar to those performed in the first embodiment.

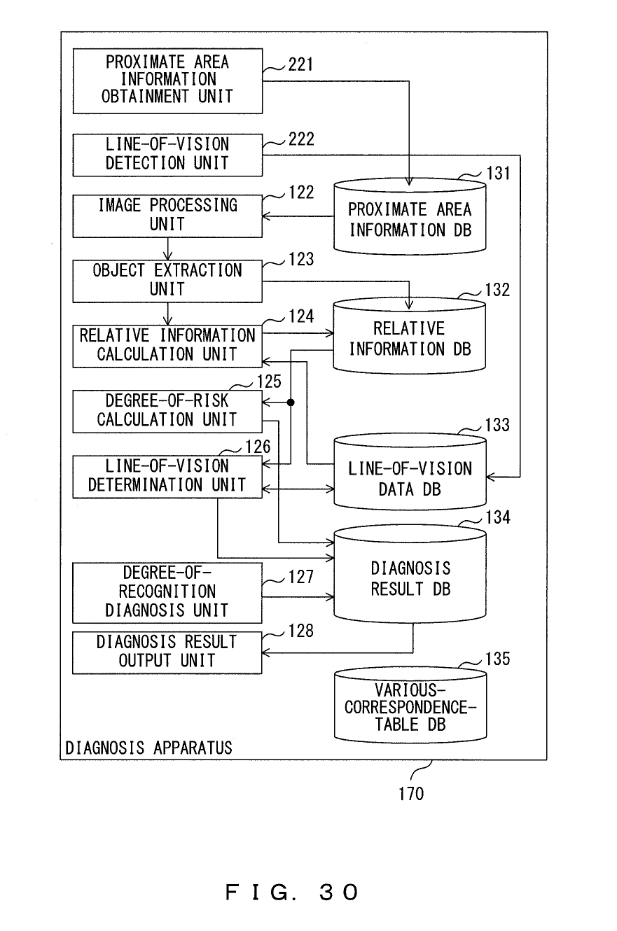

Next, the functional configuration of the diagnosis apparatus 170 will be described. FIG. 30 is an example of a block diagram illustrating the functional configuration of the diagnosis apparatus in accordance with the second embodiment. In addition to the functional configuration of the diagnosis apparatus 100 in accordance with the second embodiment, the diagnosis apparatus 170 in accordance with the second embodiment includes a proximate area information obtainment unit 221 and a line-of-vision detection unit 222. Unlike the diagnosis apparatus 100 in accordance with the first embodiment, the diagnosis apparatus 170 in accordance with the second embodiment does not need to transmit or receive data or a command to or from the information obtainment apparatus 200, and hence the transmission and reception units 121 and 223 and the various-data DB 224 are omitted.

The proximate area information obtainment unit 221 obtains a proximate area image shot by the proximate area information obtainment device 205 and stores it in the proximate area information. DB 131. The line-of-vision detection unit 222 calculates the line-of-vision origin P and the line-of-vision vector 150a indicating the direction of the line of vision 150 in accordance with the image of, for example, the driver's face, eyeball, or iris detected by the line-of-vision detection device 206, and stores the calculated line-of-vision origin P and the calculated line-of-vision vector 150a in the line-of-vision data DB 133.

Except for the fact that the diagnosis apparatus 170 in accordance with the second embodiment obtains proximate area information and information on, for example, the driver's face, eyeball, or iris by itself, the functional configuration and process flow of the diagnosis apparatus 170 are similar to those of the diagnosis apparatus 100 in accordance with the first embodiment. The modifications of the first embodiment may be incorporated into the present embodiment.

The diagnosis apparatus 170 in accordance with the present embodiment may also diagnose the degree of recognition of an object around the vehicle 300 in accordance with the positional relationship between the object and the direction of the actual line of vision of the driver of the vehicle 300, thereby enhancing the accuracy for diagnosing the degree of recognition.

### [c] Other Embodiments

A computer program for causing a computer to execute the aforementioned methods and a computer-readable recording medium in which this computer program is recorded are within the scope of the present invention. The computer-readable recording medium may be, for example, a flexible disk, a hard disk, a CD-ROM (Compact Disc-Read Only Memory), an MO (Magneto Optical disk), a DVD, a DVD-ROM, a DVD-RAM (DVD-Random Access Memory), a BD (Blue-ray Disc), a USB memory, or a semiconductor memory. The computer program is not limited to those recorded in the recording medium, and it may be transmitted via, for example, a network represented by a telecommunication circuit, a wired or wireless communication line, or the internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A diagnosis apparatus comprising:
an object extraction unit configured to extract one or more objects around a vehicle;
a line-of-vision determination unit configured to determine whether or not at least one region of the object is included in a line-of-vision space centered around a line of vision of a driver of the vehicle; and
a degree-of-recognition diagnosis unit configured to diagnose the driver's degree of recognition of the object in accordance with the determination result.

2. The diagnosis apparatus according to claim 1, wherein
the line-of-vision determination unit determines a positional relationship between the line-of-vision space and the object, and
the degree-of-recognition diagnosis unit diagnoses the degree of recognition in accordance with the positional relationship between the line-of-vision space and the object.

3. The diagnosis apparatus according to claim 2, wherein
the line-of-vision determination unit determines whether or not the at least one region of the object is included in the line-of-vision space in accordance with an angle formed by a line-of-vision vector indicating a direction of a line of vision of the driver and an object vector from the driver toward the object.

4. The diagnosis apparatus according to claim 1, wherein
the line-of-vision determination unit further calculates a viewing time during which the at least one region of the object is included in the line-of-vision space for each object, and
the degree-of-recognition diagnosis unit diagnoses the degree of recognition of each object in accordance with the viewing time.

5. The diagnosis apparatus according to claim 1, wherein
the line-of-vision determination unit further calculates a non-viewing time during which each object is located outside the line-of-vision space, and
the degree-of-recognition diagnosis unit diagnoses the degree of recognition of each object in accordance with the non-viewing time.

6. The diagnosis apparatus according to claim 5, wherein
the degree-of-recognition diagnosis unit diagnoses the degree of recognition of each object in accordance with whether or not the non-viewing time is shorter than a TTC (Time to collision) which is a time that elapses before a collision occurs between the vehicle and each object.

7. The diagnosis apparatus according to claim 1, wherein
the degree of recognition diagnosis unit diagnoses the driver's degree of recognition in accordance with a ratio between the number of objects around the vehicle and the number of objects judged by the line-of-vision determination unit to be included in the line-of-vision space from among the objects around the vehicle.

8. The diagnosis apparatus according to claim 1, wherein
when the line-of-vision determination unit determines that one or more mirrors equipped on the vehicle are along an extension of the line of vision of the driver, the line-of-vision determination unit corrects a direction of the line of vision in accordance with the one or more mirrors and determines whether or not at least one region of the object is included in a line-of-vision space centered around the corrected line of vision.

9. The diagnosis apparatus according to claim 1, further comprising
a diagnosis result output unit configured to output information on an object corresponding to the degree of recognition diagnosed by the degree-of-recognition diagnosis unit which is less than or equal to a predetermined value.

10. The diagnosis apparatus according to claim 9, further comprising:
a relative information calculation unit configured to calculate relative information for each object, the relative information including a relative speed and/or relative distance relative to the vehicle; and
a degree-of-risk calculation unit configured to calculate a degree of risk of a collision between the vehicle and each object in accordance with the relative information, wherein
the diagnosis result output unit outputs the degree of risk of a collision with the object corresponding to the degree of recognition which is less than or equal to the predetermined value.

11. The diagnosis apparatus according to claim 1, further comprising:
a relative information calculation unit configured to calculate relative information for each object, the relative information including a relative speed and/or relative distance relative to the vehicle; and
a degree-of-risk calculation unit configured to calculate a degree of risk of a collision between the vehicle and each object in accordance with the relative information, wherein
the line-of-vision determination unit determines whether or not at least one region of a hazardous object is included in the line-of-vision space, and the hazardous object is an object included in the objects and corresponding to the degree of risk of a collision with the vehicle which is equal to a predetermined threshold or greater, and
the degree-of-recognition diagnosis unit diagnoses the driver's degree of recognition of the hazardous object in accordance with the determination result.

12. A diagnosis method executed by a diagnosis apparatus, the method comprising:
extracting one or more objects around a vehicle;
determining whether or not at least one region of the object is included in a line-of-vision space centered around a line of vision of a driver of the vehicle; and
diagnosing the driver's degree of recognition of the object in accordance with the determination result.

13. A diagnosis apparatus comprising:
a proximate area information obtainment unit configured to obtain proximate area information including information on one or more objects around a vehicle;
an object extraction unit configured to extract the one or more objects from the proximate area information;
a line-of-vision detection unit configured to detect a line of vision of a driver of the vehicle;
a line-of-vision determination unit configured to determine whether or not at least one region of the object is included in a line-of-vision space centered around the line of vision of the driver of the vehicle; and
a degree-of-recognition diagnosis unit configured to diagnose the driver's degree of recognition of the object in accordance with the determination result.

14. The diagnosis apparatus according to claim 13, wherein
the proximate area information obtainment unit includes one or more image pickup apparatuses which pick up an image of an area around the vehicle, and further includes image processing unit configured to generate a proximate area image of the region around the vehicle from the image picked up by the image pickup apparatus, and
the object extraction unit extracts the one or more objects from the proximate area image.

15. The diagnosis apparatus according to claim 13, wherein
the object extraction unit obtains a sensing result from an object sensor which senses one or more objects around the vehicle, and extracts the one or more objects in accordance with the sensing result.

16. The diagnosis apparatus according to claim 13, wherein
the object extraction unit obtains object information transmitted from one or more objects around the vehicle and including a position, speed, acceleration, and/or traveling direction of the one or more objects, and extracts the one or more objects in accordance with the object information.
